(19) United States
(12) Patent Application Publication
(10) Pub. No.: US 2007/0086345 A1
(43) Pub. Date: Apr. 19, 2007

(54) DIGITAL CONTENT USE APPARATUS AND METHOD

(76) Inventors: Daisuke Yashima, Koganei-shi (JP); Satoshi Ito, Tokyo (JP); Tooru Kamibayashi, Chigasaki-shi (JP); Atsushi Ishihara, Yokohama-shi (JP); Taku Kato, Kamakura-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/531,436

(22) Filed: Sep. 13, 2006

(30) Foreign Application Priority Data
Oct. 14, 2005 (JP) 2005-300461

(51) Int. Cl. H04L 12/26

(52) U.S. Cl. 370/236

(57) ABSTRACT

According to one embodiment, the invention protects a digital content from being illicitly copied. Resource information of content data which may be permitted to be copied, and acquisition destination information of a file that describes an Adapt RE permits to copy resources are stored in the optical disc. The Adapt RE file stores an acquisition destination of a Use RE file that permits secondary use of a copy. An apparatus has a unit configured to interpret the resource information, a unit configured to determine copying conditions by acquiring an Adapt RE file as a result of interpretation, a unit configured to execute copying based on the copying conditions, and a unit configured to acquire a Use RE based on the Adapt RE and to save the Use RE in association with the copy.

### CROSS-REFERENCE TO RELATED APPLICATIONS

This application is based upon and claims the benefit of priority from Japanese Patent Application No. 2005-300461, filed Oct. 14, 2005, the entire contents of which are incorporated herein by reference.

### BACKGROUND

1. Field

One embodiment of the invention relates to a digital content use apparatus and method, and a digital content use program and covers a recording medium itself, which are effective for a case in which a digital content recorded on, e.g., an optical disc is copied to another storage device based on its use right description.

2. Description of the Related Art

For commercial digital contents such as movies, music, and the like recorded on recording media represented by DVDs (digital versatile discs), a strong copyright protection method has been developed in the form advantageous to the contents provider side. This copyright protection method and technique provide a very rigid and robust scheme to meet a strong demand for copy protection of digital contents, and further limit the degree of freedom of the users compared to those of analog contents.

Under such situation, a field that describes whether or not a first-generation copy of a content is permitted is assured in the DTCP (Digital Transmission Content Protection) standard as the communication standard of home appliances, thus providing a technique for limiting copying actions.

On the other hand, in ISO/IEC 21000 (MPEG21) series that aims at distribution and management of digital contents in various forms, the right description language (REL (Right Expression Language)) has been standardized. This REL allows a flexible use right description (Right Expression: to be abbreviated as RE hereinafter). Patent reference 1 (U.S. Pat. No. 5,629,980) has proposed a method and the like of performing use control by appending this RE to contents.

Also, Patent reference 2 (Jpn. Pat. Appln. KOKAI Publication No. 2002-176549) has proposed a technique which embeds copyright information associated with a content of a quoted part to allow rights inheritance and to protect the RE of an original work when a secondary work is produced by quoting the original work and its copyright information is edited to have a description of right information of the secondary work as the central aim.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing the configuration of overall functional blocks according to an embodiment of the invention;

FIG. 2 is an explanatory diagram showing an overview of the processing flows to explain the operation of the overall functional blocks shown in FIG. 1;

FIG. 3 is a flowchart presented to explain the former half processing in the embodiment shown in FIG. 1;

FIG. 4 is a flowchart presented to explain the latter half processing in the embodiment shown in FIG. 1;

FIG. 5 is an operation explanatory chart of a minimum protocol to obtain protection of data to be protected in the embodiment shown in FIG. 1;

FIG. 6 is an exemplary block diagram showing the configuration of overall functional blocks according to another embodiment;

FIG. 7A shows an example of the format of license information used in the embodiment;

FIG. 7B is a block diagram showing an example of the configuration of functional blocks used to execute the minimum protocol described using FIG. 5;

FIG. 8 is an exemplary block diagram showing the configuration of overall functional blocks according to still another embodiment;

FIG. 9 is an explanatory view showing an example of the RDF data structure (RG Set) associated with the invention;

FIG. 10 is an explanatory view showing a description example of an Adapt RE associated with the invention;

FIG. 11 is an explanatory view showing a description example of a Use RE associated with the invention;

FIG. 12 is an explanatory view showing a description example of a Profile DIA of a Player;

FIG. 13 is a flowchart showing the overall operation of the embodiment shown in FIG. 8;

FIG. 14 is a flowchart showing details of the RDF acquisition step in FIG. 13;

FIG. 15 is a flowchart showing details of the Adapt REF acquisition step in FIG. 13;

FIG. 16 is a flowchart showing details of the Adapt REF determination step in FIG. 13;

FIG. 17 is a flowchart showing details of the RG transcoding and save processing step in FIG. 13;

FIG. 18 is a flowchart showing the second embodiment of the RDF processing step in FIG. 13;

FIG. 19 is a flowchart showing the third embodiment of the RDF processing step in FIG. 13;

FIG. 20 is a flowchart showing another embodiment of the Adapt REF acquisition step in FIG. 13;

FIG. 21 is an exemplary block diagram showing the configuration of overall functional blocks according to yet another embodiment;

FIG. 22 is a flowchart showing an example of the operation of the overall functional blocks in FIG. 21;

FIG. 23 is a flowchart showing details of the Player Profile acquisition step in FIG. 22;

FIG. 24 shows a description example of MCD Capability associated with the invention;

FIG. 25 is an explanatory chart of the operation of a minimum protocol to obtain protection of data to be protected according to another embodiment of the invention;

FIG. 26 shows an example of the format of license information in the embodiment shown in FIG. 25;

FIG. 27 is a block diagram showing the block configuration of the overall apparatus corresponding to the explanation of the operation of FIG. 25;

FIG. 28 is an explanatory chart of the operation of a minimum protocol to obtain protection of data to be protected according to still another embodiment of the invention;

FIG. 29 shows an example of the format of license information in the embodiment shown in FIG. 28;

FIG. 30 shows an example of the format of server certificate information in the embodiment shown in FIG. 28; and

FIG. 31 is a block diagram showing the block configuration of the overall apparatus corresponding to the explanation of the operation of FIG. 28.

### DETAILED DESCRIPTION

Various embodiments of the invention will be described hereinafter with reference to the accompanying drawings.

<Objectives>

In recent years, home networks have prevailed, and demands for saving digital contents that the users rightfully get in servers (storages) in home are increasing.

In order to meet such demands, contents must be protected from unauthorized copies. On the other hand, a technique for permitting a copy under appropriate use control is required. In this case, a content as a copy source and its copy are required to have different right descriptions (Right Expressions: REs), and must be adapted to the performance, attributes (DRM), and the like of a target device of the copy. When it is impossible to update the recorded contents like a DVD-ROM, a scheme that can update the RE is required.

By contrast, the scheme provided by the DTCP standard allows to generate a copy of a content based on designation of COPY_ONCE, but the copy has status COPY_NO_MORE and its use is limited to only playback by an authenticated device. Also, other conditions for playback cannot be added.

The MPEG-21 REL allows a flexible RE using XML, and has a scheme of delegation control that delegates the RE setting of a content to a third party under limitations defined in advance. However, the MPEG-21 REL has no scheme for controlling a use description for a new content generated by a “copying” action.

Furthermore, patent reference 2 (Jpn. Pat. Appln. KOKAI Publication No. 2002-176549) has proposed a method of inheriting the use conditions of an original content to a secondary work, but a new RE cannot be provided to the secondary work. Furthermore, since both patent reference 1 (U.S. Pat. No. 5,629,980) and patent reference 2 (Jpn. Pat. Appln. KOKAI Publication No. 2002-176549) assume that a copy is processed by a similar DRM, they cannot cope with a case having a different DRM scheme.

One embodiment of the invention has been made in consideration of the above situation, and has as its object to provide a digital content use apparatus, digital content use method, and digital content protection program, which protect a digital content saved in an optical disc from being illicitly copied, permit a copy of the digital content under an appropriate RE, and allow use control of the copy based on another new RE. In this manner, flexible designation can be made to allow secondary, diversified use of a copy.

<Basic Measure by Embodiment>

One embodiment handles an optical disc (3) that describes content data, a resource description file (RDF) including acquisition destination information of an adapt right description file (Adapt REF) which describes resource information, identification information, and the execution contents and conditions of copying of the content to be handled as units of copying processing, disc identification information (Disc ID), and a disc serial number (Disc SN).

Also, a disc device (2) that reads information from this optical disc (3), and a communication start unit (1B) which transmits the read disc identification information to a server are used. The server supports the disc identification information.

Upon returning first key information (random number 1) from the server, a first response unit (1C) transmits information generated by appending a tamper-resistant code (Message Authentication Code (MAC)) to the disc serial number using the first key information, second key information (random number 2), and a target profile of a player to be used to the server. The server verifies whether or not the MAC is normal, and determines whether or not the disc serial number is authentic.

When a second response unit (1D) receives license information which includes the disc serial number, target profile, transcoding information used in resource copying, and use limitation information (Use REF) that imposes use limitations on the copied content, it stores the Use REF in a storage, and supplies the transcoding information to a transcoding and save unit (10) which transcodes the resource and saves it in the storage. Also, a method of implementing the aforementioned processing is provided.

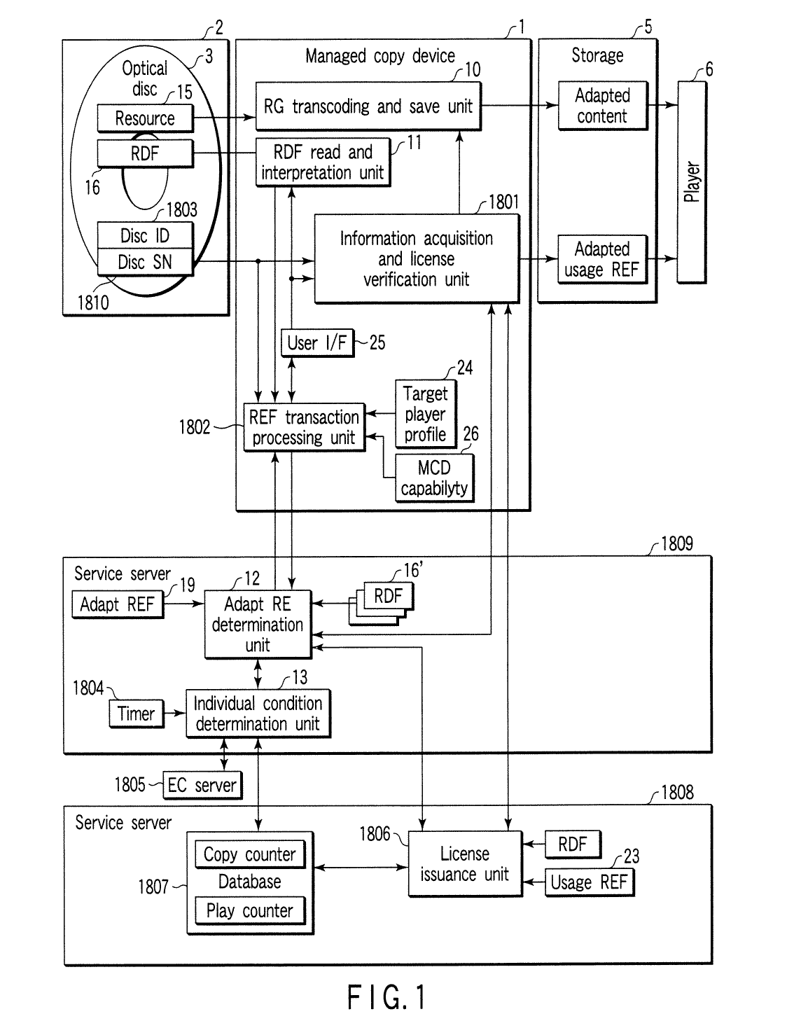

The best mode of carrying out the invention of a digital content use apparatus, digital content use method, and digital content use program will be described in detail hereinafter with reference to the accompanying drawings. FIG. 1 is a functional block diagram showing the first embodiment. This embodiment comprises, for example, a managed copy device (MCD) 1, optical disc device 2, external storage 5, player 6, license server 1808, service server 1809, and EC server 1805. In this example, the managed copy device 1, service server 1809, and license server 1808 are connected via a network. The optical disc device 2 can drive an optical disc 3.

The optical disc 3 records, as a content, a resource which is to undergo managed copy, a resource description file (to be abbreviated as RDF hereinafter), a disc ID as a disc unique ID indicating the type of the optical disc 3, and a disc serial number (Disc SN) as a serial number used to manage each optical disc 3 per disc. The RDF describes, for example, a URI to be accessed by the managed copy device 1 and the like.

The managed copy device 1 has an RG transcoding and save unit 10 which processes a resource group (to be referred to as RG hereinafter), and an RDF read and interpretation unit 11 which processes the RDF. The managed copy device 1 holds, as data, a Target Player Profile 24, user interface 25, and MCD Capability 26. The Target Player Profile 24 is information that describes the performance of the player 6 (a description example thereof will be described later). The user interface 25 is used to communicate with the user, and utilizes a GUI or the like. The MCD Capability 26 is information that describes the performance and the like of this managed copy device 1 (to be described later).

The managed copy device 1 has an information acquisition and license verification unit 1801. The information acquisition and license verification unit 1801 communicates with the license server 1808 via the service server 1809. Then, the unit 1801 transmits information unique to the optical disc 3 which is required for the license in a protected form, verifies the received license information, and notifies the RG transcoding and save unit 10 of the verification result.

The managed copy device 1 has an REF transaction processing unit 1802. This REF transaction processing unit 1802 notifies the service server 1809 of conditions for determining individual conditions and user's choices notified by the user interface 25. The individual conditions are required upon copying, and use a description format to be described later.

The storage 5 comprises a storage medium such as a hard disc drive (HDD), DVD device, memory, and the like, and is used as a home server of the user.

The service server 1809 has an Adapt RE determination unit 12 and an individual condition determination unit 13, and mediates a communication with the license server 1808. The service server includes an Adapt REF 19 that describes the determination conditions of an Adapt RE, and a timer 1804 used to determine a time condition as one of the individual conditions to be determined. When an accounting condition or the like is included as one of the individual conditions, the service server 1809 also makes a communication with an EC (electronic commerce) server 1805 that performs accounting. The individual conditions may include those other than the conditions described above, and the invention does not particularly limit other individual conditions. The service server 1809 has RDFs 16′ used to collate the RDF 16 of the disc.

The license server 1808 manages license information for each optical disc. The license server 1808 has a database 1807 used to manage license information. The database 1807 holds previous license information for each individual optical disc, and holds latest information by updating a play counter and copy counter as needed, which can be used as information for making a decision as to whether or not copying is licensed. The license server 1808 has a license information issuance unit 1806 which communicates with the managed copy device 1 via the service server 1809, and generates license information, and includes a Use REF included in the license information and an RDF including RG information.

Note that classifications of the license server and service server are logical ones, and they may be physically implemented by an identical site.

The copy counter and the play counter included in the license server 1808 should be originally used as components for determining the individual conditions. However, these counters are not building components of the service server 1808 but are those of the license server 1808. This is because the copy counter and the play counter are information to be managed per disc, and are information which can be managed by only the license server 1808.

For example, the license server 1808 may entrust a plurality of servers with the role of the service server that executes managed copy. In this case, the copy counter and the play counter must be uniformly managed by the license server 1808, but they cannot be managed by the individual service servers.

On the other hand, information for determining and deciding the time condition, the accounting condition, the type of the DRM used by the Target Player 6 for which managed copy is executed, the range of a resource which is to undergo managed copy, and the like is information used per managed copy, and need not be saved in association with each disc. The processing of these conditions can be executed by the service server 1809.

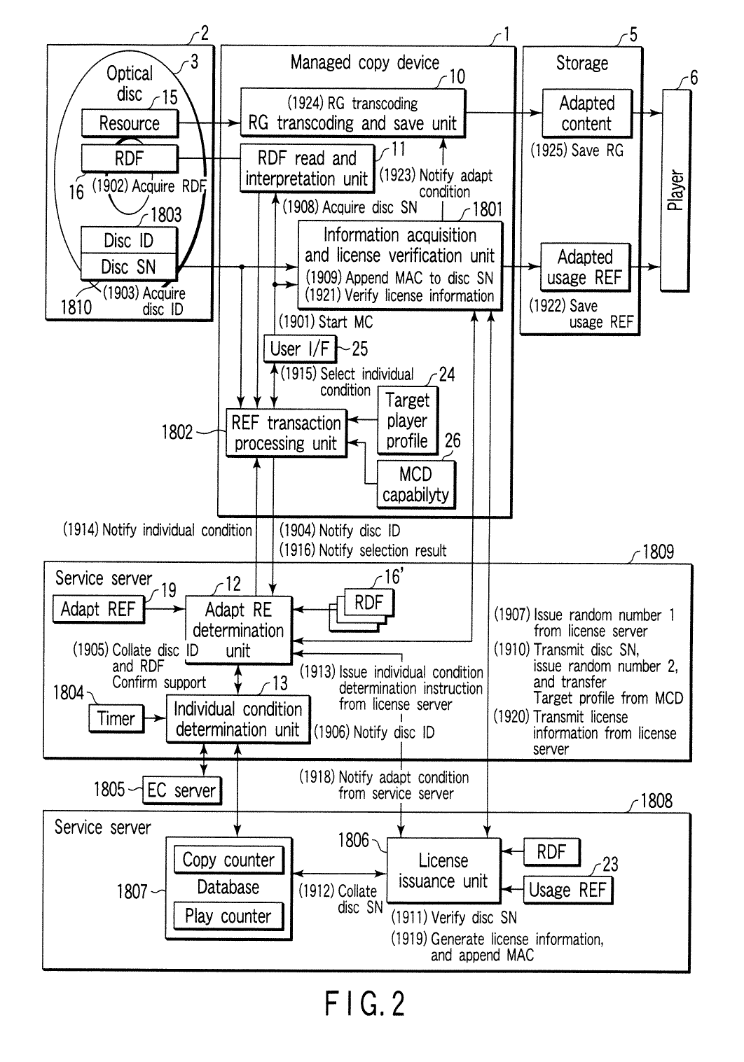

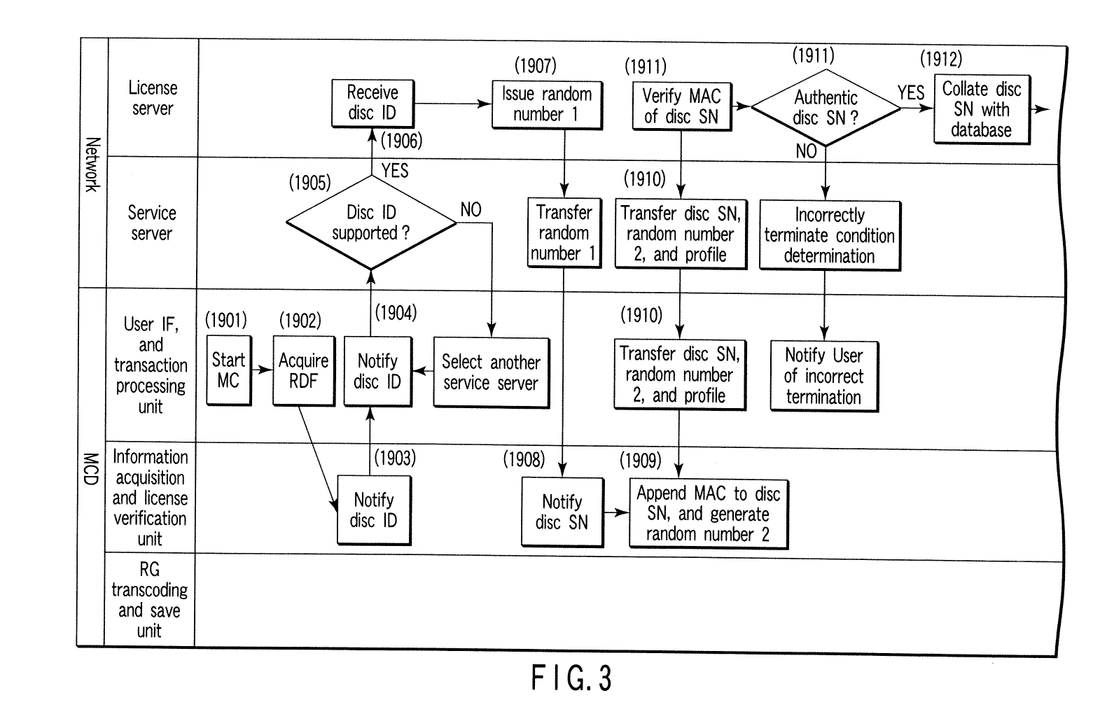

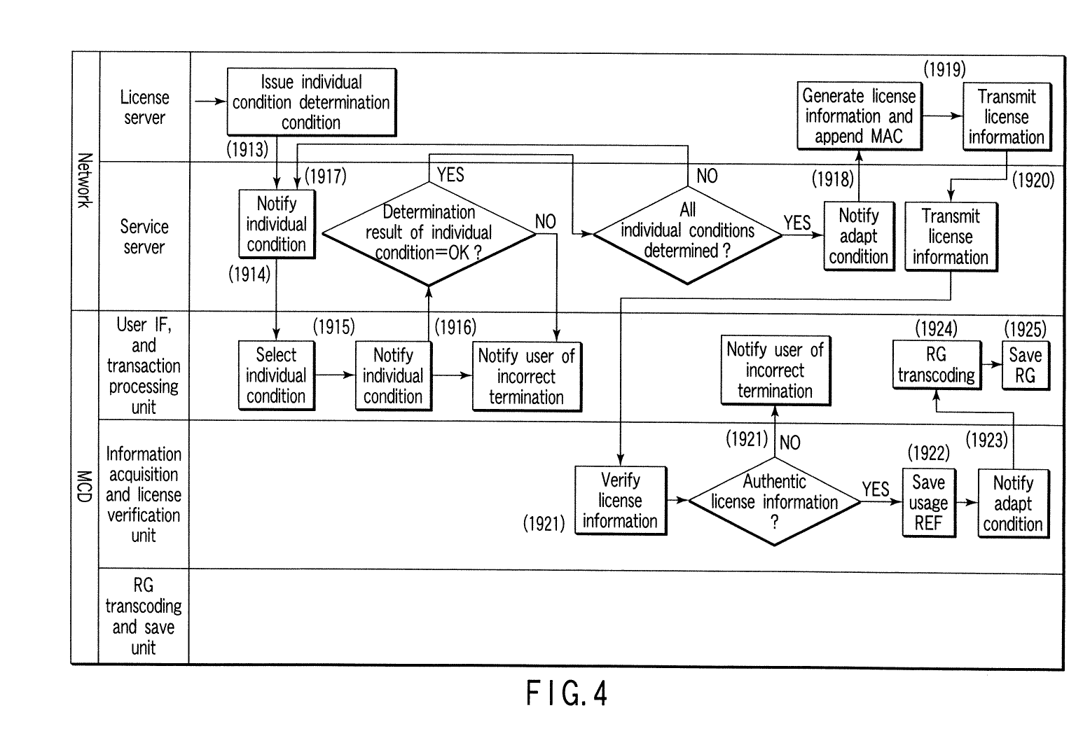

FIG. 2 is a diagram prepared by describing the overall processing flows on the functional block diagram shown in FIG. 1. These processing flows are indicated as processing sequences (1901) to (1925). FIGS. 3 and 4 respectively show the former half and the latter half of the operation flowchart of the embodiment shown in FIG. 1. In FIGS. 3 and 4, the configuration of the overall functional blocks is roughly divided into five layers, and principal functional blocks included in the respective layers are (1) the license server, (2) the service server, (3) the user INTERFACE and RF transaction processing unit, (4) the information acquisition and license verification unit, and (5) the RG transcoding and save unit. The processing shown in these flowcharts is the same as that shown in FIG. 2, and their correspondence is indicated by numbers (1901) to (1925) of the processing in FIG. 2.

The overall operation will be described below with reference to FIGS. 2, 3, and 4. The user instructs the RDF read and interpretation unit 11 and the information acquisition and license verification unit 1801 to start copying via the user interface 25 (1901: start MC). The RDF read and interpretation unit 11 reads a resource description file (RDF) from the optical disc 3, and processes it according to a protection scheme defined by the optical disc standard and the like, thus setting the RDF to be ready to use (1902: acquire RDF).

The information acquisition and license verification unit 1801 reads the disc identification information (Disc ID) 1803 from the optical disc 3 (1903: acquire Disc ID). The Adapt RE determination unit 12 of the service server 1809 is notified of the read Disc ID 1803 via the REF transaction processing unit 1802. The URI of the service server 1809 to be accessed at that time is described in the RDF (1904: notify Disc ID).

The Adapt RE determination unit 12 collates the received Disc ID 1803 and the RDFs 16′ held in the service server 1809 to confirm if the Disc ID 1803 is the one that the service server 1809 can handle. At this time, if the ID cannot be handled, a message that advices accordingly is sent to the managed copy device 1.

At this time, if another accessible URI is available, the managed copy device 1 similarly sends the Disc ID 1803 to it. If the Disc ID is not supported by all the URIs defined in the RDFs 16′ of the managed copy device 1, a message indicating that managed copy cannot be made is sent to the user via the user interface 25 (1905: collate Disc ID and RDF, and confirm support).

If the Disc ID 1803 is the one that the service server 1809 can handle, the license server 1808 that manages license information is notified of the Disc ID 1803 (1906: notify Disc ID).

Upon reception of the Disc ID 1803, the license issuance unit 1806 of the license server 1808 generates random number 1, and transmits it to the information acquisition and license verification unit 1801 of the managed copy device 1 via the service server 1809 (1907: issue random number 1 from license server).

The managed copy device 1 reads out the Disc SN 1810 from the optical disc 3, and sends it to the information acquisition and license verification unit 1801 (1908: acquire Disc SN).

The information acquisition and license verification unit 1801 generates a key from a key unique to the optical disc 3 which is generated based on the Disc ID 1803, and the received random number 1 according to a predetermined method. Using this key, the information acquisition and license verification unit 1801 appends a tamper-resistant code MAC (Message Authentication Code) to the Disc SN 1810. This MAC is a code used to prevent tampering, and can be generated by only a person who knows its generation method and the key value (1909: append MAC to Disc SN).

The managed copy device 1 generates random number 2 using the information acquisition and license verification unit 1801, and transmits the Disc SN 1810 to which the MAC is appended by the information acquisition and license verification unit 1801, Target Player Profile, and random number 2 to the license issuance unit 1806 of the license server 1808 (1910: transmit Disc SN from MCD). The Target Player Profile may be simply called a Target Profile.

The license issuance unit 1806 verifies the MAC appended to the received Disc SN 1810 using the key unique to the optical disc 3, which is generated based on the Disc ID 1803, and the key generated based on the transmitted random number 1 (1911: verify Disc SN).

If it is determined as a result of verification that the MAC is not authentic, the license server 1808 notifies the service server 1809 of incorrect termination of the processing. The service server 1809 then notifies the managed copy device 1 of incorrect termination of the processing. The managed copy device 1 notifies the user of incorrect termination of the processing via the user interface 25.

On the other hand, if it is determined as a result of verification that the MAC is authentic, the license server 1808 collates the contents of the database with the received Disc SN 1810, and checks whether the optical disc 3 having that Disc SN 1810 can undergo managed copy (1912: collate Disc SN).

If the optical disc 3 can undergo managed copy, the license server 1808 instructs the service server 1809 to determine the individual conditions. As the instruction issued at this time, the service server 1809 may be notified in advance of the individual conditions to be determined, or of different individual conditions to be determined every time in correspondence with the information of the database 1807. At this time, if information of the database 1807 is used as one of the individual conditions to be determined, the required information on the database 1807 is sent to the service server 1809 together with the individual condition determination instruction (1913: issue individual condition determination instruction by license server).

Upon reception of the individual condition determination instruction, the service server 1809 notifies the managed copy device 1 of individual conditions to be determined. As the individual conditions to be notified at that time, only those which include information disclosure, condition selection, accounting that requires user's payment, and the like (1914: notify individual condition).

Upon reception of the individual conditions, the managed copy device 1 notifies the user of the conditions via the user interface 25. The user executes condition selection and the like in accordance with the user interface 25 (1915: select individual condition).

The selection result is returned to the service server 1809 via the REF transaction processing unit 1802 (1916: notify selection result). The individual condition determination unit 13 in the service server 1809 determines conditions that can be determined within the service server, and executes processing of the condition such as accounting or the like by communicating with the EC server 1805 (1917: determine individual condition). If all the individual conditions are satisfied, the service server 1809 notifies the license server 1808 of an agreed Adapt condition (1918: notify Adapt condition).

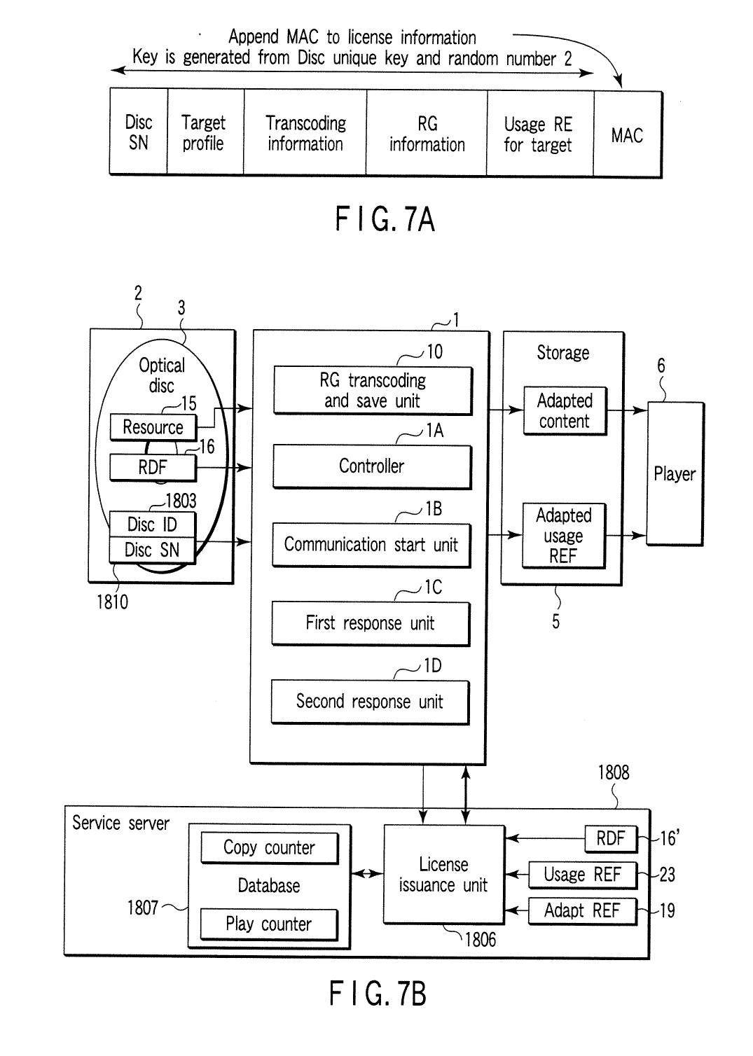

Upon reception of the Adapt condition, the license issuance unit 1806 of the license server 1808 generates license information. As in an example of the format (FIG. 7A) to be described later, the license information includes the Disc SN 1810, the Target Profile, transcoding information as the received Adapt condition, RG information, and a Use RE for Target, which is held in the license server 1808 and is selected in correspondence with the Target Profile, and the MAC is appended to these pieces of information as a whole.

The key used to generate the MAC is generated based on the key unique to the optical disc 3, which is generated based on the Disc ID 1803, and the received random number 2 in accordance with the predetermined method (1919: generate license information, and append MAC).

The license server 1808 notifies the information acquisition and license verification unit 1801 of the managed copy device 1 of the generated license information via the service server (1920: transmit license information).

The information acquisition and license verification unit 1801 verifies the MAC appended to the received license information using the key unique to the optical disc 3, which is generated based on the Disc ID 1803, and the transmitted random number 2. Also, the unit 1801 confirms whether the Disc SN 1810 and Target Profile included in the license information are values sent by the managed copy device 1 (1921: verify license information).

If the MAC appended to the license information is authentic, and the Disc SN 1810 and Target Profile included in the license information are values sent by the managed copy device 1, the Use RE for the Target (use limitation information of copy data for the target device) included in the license information is saved in the external storage 5 as a Use REF that the Target Player should follow (1922: save Use REF).

Next, the information acquisition and license verification unit 1801 notifies the RG transcoding and save unit 10 of the transcoding information and the RG information as the Adapt condition included in the license information (1923: notify Adapt condition).

The RG transcoding and save unit 10 reads a resource which is to undergo managed copy from the optical disc 3 in accordance with the received RG information, and transcodes the RG in accordance with the transcoding information. In this transcoding processing, the transcoding information may designate transcoding of the protection scheme, RG bind with respect to the player 6, changes of the playback scheme and playback rate of the content, and the like (1924: RG transcoding processing). The RG transcoded by the RG transcoding and save unit 10 is saved in the external storage 5 (1925: save RG).

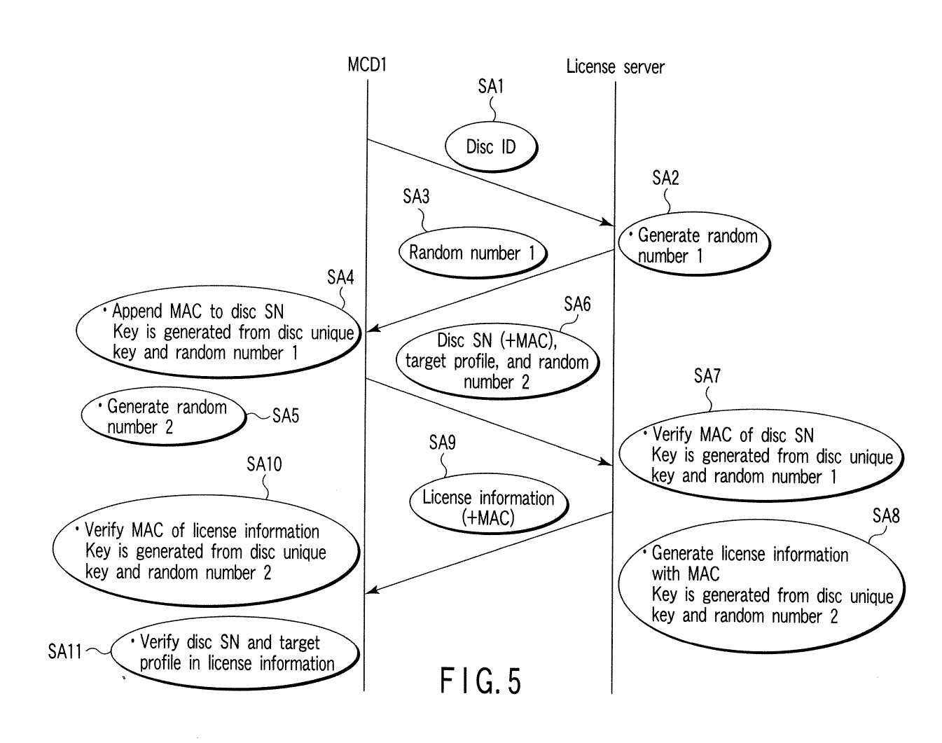

FIG. 5 shows a minimum protocol used to protect data to be protected in this embodiment. This minimum protocol is handled by the managed copy device (MCD) 1 and the license server 1808, and the service server 1809 need not become involved in the contents of data to be handled.

For this reason, even when processing such as MAC generation and the like used in the minimum protocol is based on a cryptographic technique that requires licensing or the like, the service server 1809 can be managed without any constraint.

Items defined by this protocol are the types of data to be exchanged and their protection and verification methods, and a protocol as a transmission path used to exchange data is not particularly designated. For this reason, no problem is posed even when the service server 1809 which cannot interpret the minimum protocol relays a communication between the managed copy device 1 and license server 1808.

In the minimum protocol, the managed copy device 1 transmits the Disc ID 1803 to the license server 1808 (step SA1). This information is used by the license server 1808 to recognize the type of the optical disc 3.

The license server 1808 generates random number 1 (step SA2), and transmits it to the managed copy device 1 (step SA3). The managed copy device 1 generates a key for a MAC based on a Disc unique key based on the Disc ID 1803 as information unique to the optical disc 3, and the received random number 1, and appends the MAC to the Disc SN 1810 (step SA4). The Disc unique key is information which is hidden not to be generated by devices other than the licensed device. Since random number 1 is used for this MAC, not only tampering can be prevented, but also the MAC can be prevented from being counterfeited by a third party, and the Disc SN 1810 appended with the MAC can be prevented from being repetitively used without recalculating the MAC value.

Furthermore, the managed copy device 1 generates random number 2 (step SA5), and transmits it to the license server 1808 together with the Target Profile and the Disc SN 1810 appended with the MAC (step SA6).

The license server verifies the MAC of the received Disc SN 1810 (step SA7). Since a key used in verification is generated based on the Disc unique key based on the Disc ID 1803 and random number 1 in the same manner as the key used to generate the MAC, the license server 1808 can verify the MAC.

If it is confirmed that the MAC of the Disc SN 1810 is authentic, the license server 1808 generates license information (see FIG. 7A). The license information includes information indicating the contents of the license, the Disc SN 1810, and the Target Profile. For the purpose of preventing the license information from being used by a different managed copy device, the license information includes information transmitted from the managed copy device 1. Furthermore, a key for the MAC is generated based on the Disc unique key based on the Disc ID 1803 as information unique to the optical disc 3, and the received random number 2, and the MAC is appended to the entire license information, thus transmitting the license information (SA8, SA9). Since random number 2 is used in this MAC, not only tampering can be prevented, but also the MAC can be prevented from being counterfeited by a third party, and the Disc SN 1810 appended with the MAC can be prevented from being repetitively used without recalculating the MAC value.

The managed copy device 1 verifies the MAC of the received license information (SA10). Since a key used in verification is generated based on the Disc unique key based on the Disc ID 1803 and random number 2 in the same manner as the key used to generate the MAC, the managed copy device 1 can verify the MAC.

Furthermore, the managed copy device 1 confirms whether the Disc SN 1810 and Target Profile included in the license information are the same as those transmitted by itself (step SA11).

With the above-mentioned protocol, the managed copy device 1 and the license server 1808 confirm that each others devices do not camouflage, and can exchange information required for licensing without apprehending use of transmitted information by a third party or use of illicit, repetitive use of transmitted information. If the cryptographic technique used in the MAC is the one that requires licensing, they can confirm that each others devices are licensed.

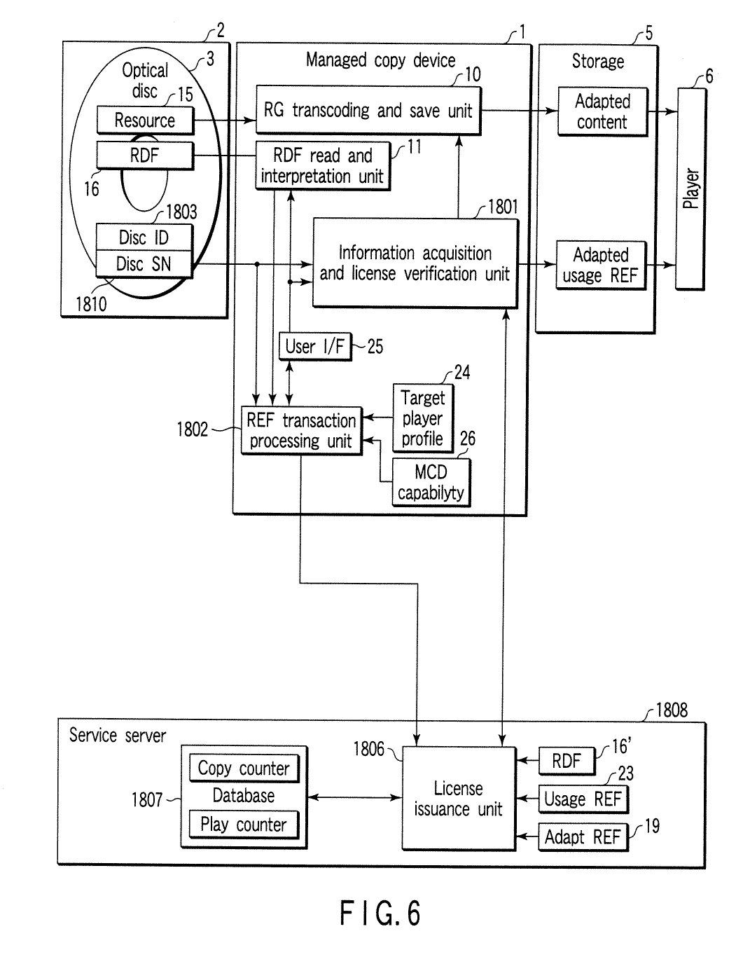

FIG. 6 shows an example of the system built based on the minimum protocol shown in FIG. 4. The same reference numerals in FIG. 4 denote parts that obtain the same functions as those in FIG. 1. In this example, the license server 1808 holds an RDF 16′ and Adapt REF 19. Other arrangements are the same as those in FIG. 1.

FIG. 7A shows an example of the format of the aforementioned license information. The license information includes, as data, the Disc SN 1810 as a value unique to the target optical disc 1 per disc, a Target Profile of the player which uses a resource that has undergone managed copy, transcoding information and RG information as the license contents, and a Use REF for Target that defines use limitations of the resource that has undergone managed copy. In order to protect all these data from tampering, a MAC is appended. The Use REF for Target, and a copy transcoded based on the RG information are stored in the storage 5.

Therefore, the player 6 is designed to read the use limitation information (Use REF), and to handle the copy according to the limitation contents upon playback. The player 6 operates while being completely separated from the MCD 1.

The order of these data need not always be the same as that shown in FIG. 7A, and the effects of the invention can be provided without any problem as long as the license information is configured in an order determined in advance, and the entire information is protected using the MAC.

The block configuration of the apparatus of the invention is not limited to that of the above embodiment. For example, the optical disc 3 may describe an Adapt REF, and the managed copy device 1 may include the Adapt RE determination unit 12, individual condition determination unit 13, and the like.

FIG. 7B shows a configuration example of functional blocks which implement the minimum protocol described using FIG. 5. A communication start unit 1B includes at least the read and interpretation unit 11 which reads and interprets an RDF, and the REF transaction processing unit 1802 which transmits the interpreted acquisition destination information to the server. A first response unit 1C includes at least the REF transaction processing unit 1802 which reads the disc serial number, and a second response unit (1D) includes at least information acquisition and license verification unit 1801 which receives license information.

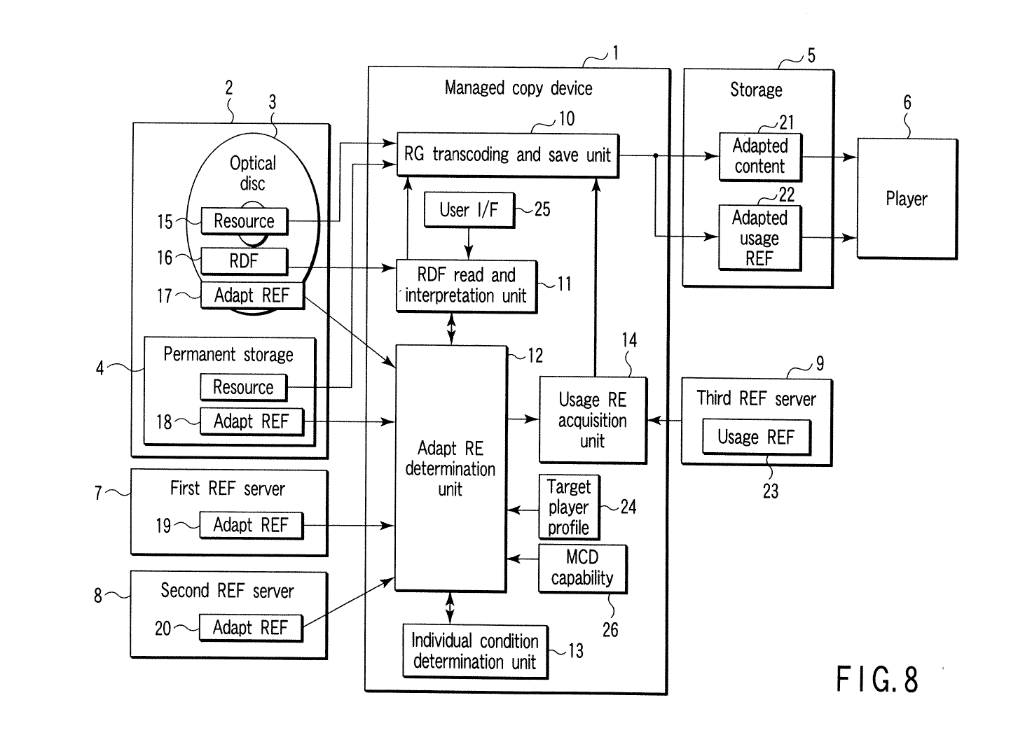

FIG. 8 shows still another embodiment. In this embodiment, a digital content use apparatus is configured by a managed copy device 1, optical disc device 2, external storage 5, player 6, first REF server 7, second REF server 8, and third REF server 9. The managed copy device 1 is further configured by an RG transcoding and save unit 10 which processes a resource group (to be referred to as an RG hereinafter), an RDF read and interpretation unit 11 which processes a Resource Descriptor File (to be referred to as RDF hereinafter), an Adapt RE determination unit 12, an individual condition determination unit 13, a Use RE acquisition unit 14, and a user interface 25. The managed copy device 1 holds, as data, a Target Player Profile 24 and MCD Capability 26.

The optical disc drive 2 has a permanent storage 4, and can drive an optical disc 3. The optical disc 3 saves a Resource 15, RDF 16, and Adapt RE file (Adapt REF) 17 as components of a content. The permanent storage 4 may often include a Resource 15 and Adapt REF 18.

The first REF server 7 saves an Adapt REF 19, and the second REF server 8 saves an Adapt REF 20. The third REF server 9 saves a Use REF 23. These servers may be physically implemented at an identical site since they are logical ones.

On the other hand, the external storage 5 saves an Adapted content 21 and Adapted Use REF 22.

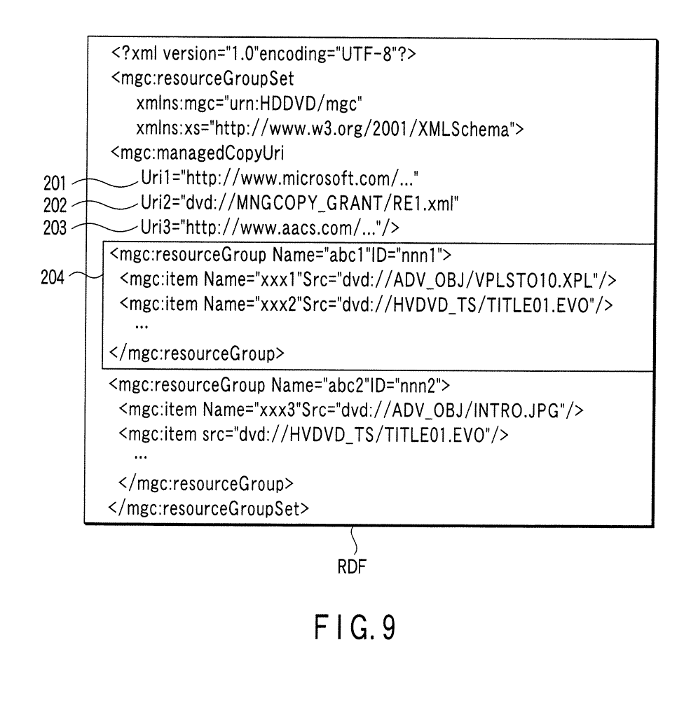

FIG. 9 shows an example of the data structure of the RDF 16. This data structure is the same as the embodiment shown in FIG. 1. Referring to FIG. 9, a content data group which may be permitted to be copied is expressed as a resource group set (RG Set). The RG Set can have a plurality of RGs 204 as its elements. This RG is a unit for a copying operation, and can handle an arbitrary resource as its element. For example, the RG can designate a series of video objects, or can be a playlist which specifies the playback order. Furthermore, the RG may designate a software program.

In the RG Set, Uri's (201 to 203) used to describe acquisition destinations of, e.g., three Adapt REs are prepared. Of these Uri's, Uri1 indicates an Adapt RE in a site of the contents provider, Uri2 indicates the Adapt RE which is described in advance in the optical disc of interest or the permanent storage, and Uri3 indicates an Adapt RE at a backup site managed by a permanent organization.

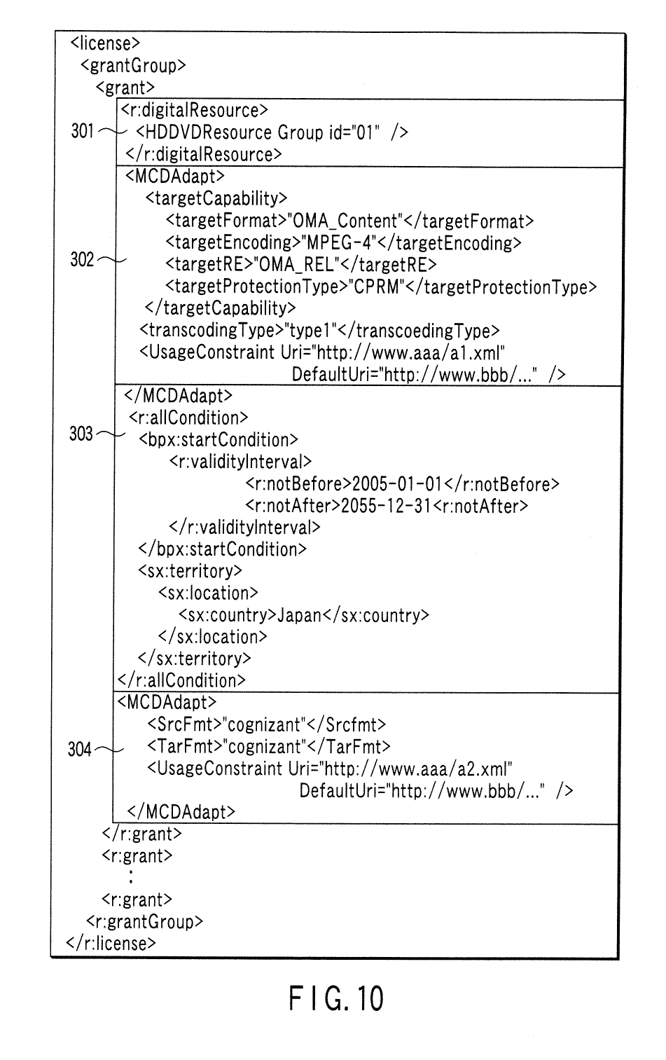

FIG. 10 shows an example of the description of the Adapt RE using a format similar to the MPEG-21 REL. In this example, this description is called <grant>. In FIG. 10, reference numeral 301 denotes a Resource Group (to be abbreviated as RG hereinafter) to be copied. Information 302 for a copying operation that can be licensed is described together with parameters required to determine the format of a copy destination and an acquisition destination <UseConstraint> of a Use RE used to apply use control of a copy. This copying operation is executed when conditions 303 to copy are satisfied. For example, as the conditions 303, a validity interval, area, and the like are described.

In this embodiment, the information 302 for the copying operation includes <targetCapability> and <transcodingType>. The former describes information associated with the capability of a target player, and the latter describes an actual transcoding scheme. In the expression of this embodiment, if this value is Type1, the type of the target player is used; if it is Type2, the same type as that of the copy source is used.

The conditions 303 cite individual conditions, which are respectively evaluated by the individual condition determination unit 13. In MPEG-21, the overall determination of conditions is checked based on the logical product of respective conditions. The field of the invention must handle status Unknown since it is premised on that it often becomes impossible to determine each individual condition, and this is a great characteristic feature.

For example, the conditions describe the validity interval, but the managed copy device does not often have a secure timer. Therefore, in order to make the overall determination, the following arithmetic method F is used in place of a Bool function.

[Table 1]

y=F(x1, x2): y is the overall determination, and x1 and x2 are individual condition determination results

| | x1 = True | x1 = False | x1 = Unknown |
|---|---|---|---|
| x2 = True | y = True | y = False | y = Unknown |
| x2 = False | y = False | y = False | y = False |
| x2 = Unknown | y = Unknown | y = False | y = Unknown |

The example of FIG. 10 describes an operation 304 when the overall determination result is Unknown. The copying operation 304 designates a different Use RE as the one after copying. For example, when it is impossible to determine a condition, only playback that lowers the resolution of a content may be permitted.

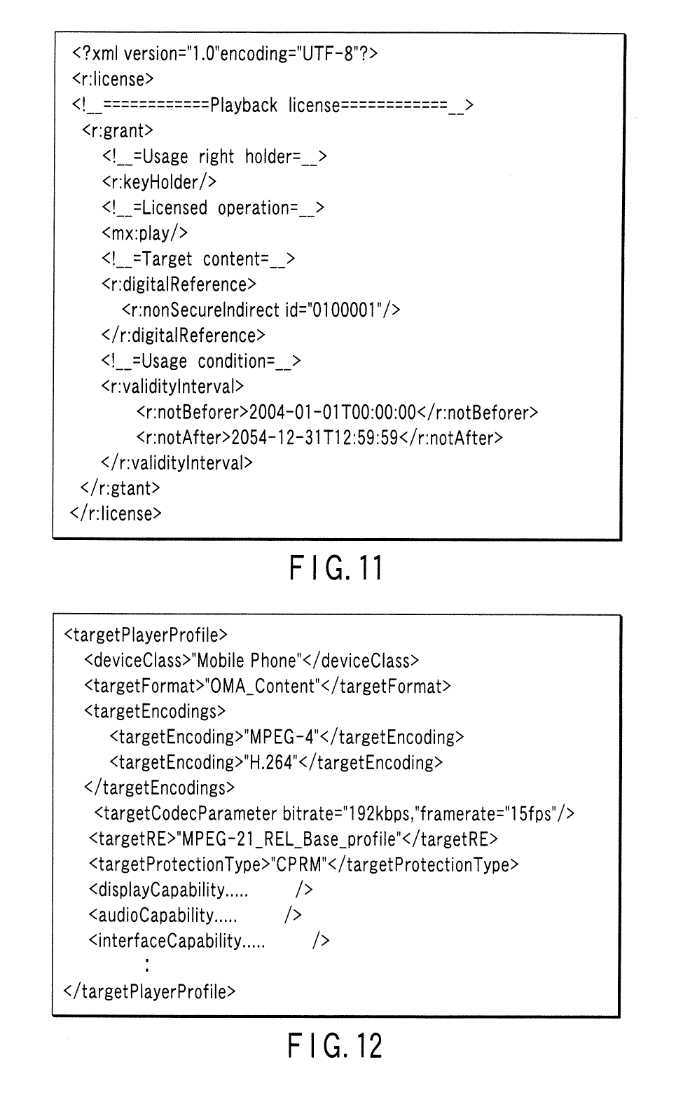

FIG. 11 shows an example of the description of the Use RE using the MPEG-21 REL. In FIG. 11, as a use license for a copy, playback within a predetermined period of time is permitted. For example, the Use RE describes use conditions such as a use right holder, contents that can be operated (licensed operation), a target content, a validity interval, and the like. A copied content can be secondarily used later according to the contents of these limited conditions.

FIG. 12 shows a description example of the Target Player Profile 24. This example describes characteristic information of the target player.

This Profile is used when suitable <grant> is retrieved from a plurality of <grant>s described in the Adapt RE, as shown in FIG. 10. The Profile may use an existing Profile format by introducing an appropriate matching method and, for example, ISO/IEC 21000-7 (MPEG-21 DIA: Digital Item Adaptation) or the like may be used.

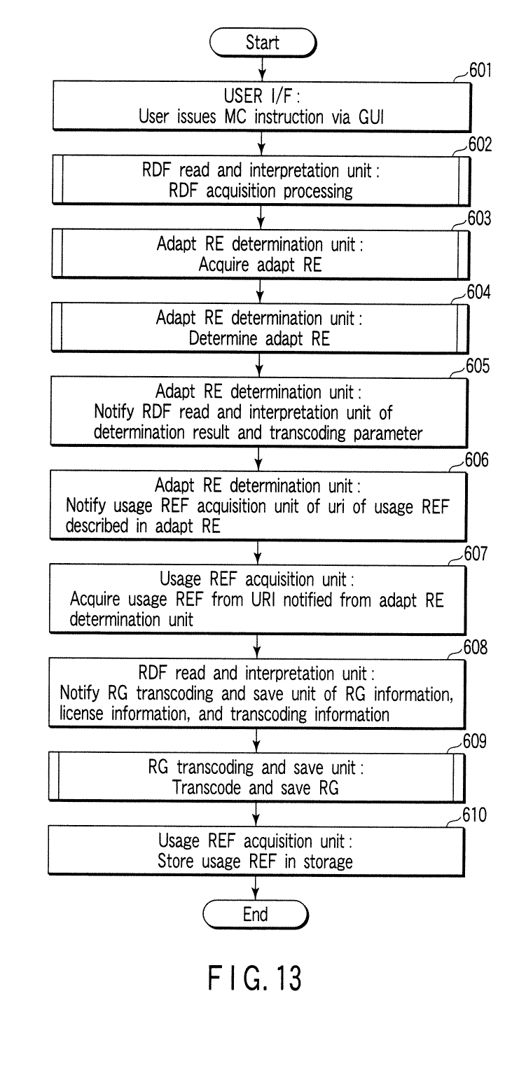

FIG. 13 is an operation flowchart showing the overall processing of the functional blocks of the system shown in FIG. 8. However, this operation flowchart can be applied to the operation flow for the functional blocks shown in FIG. 1 by only changing some steps and adding steps of communicating with servers via the network.

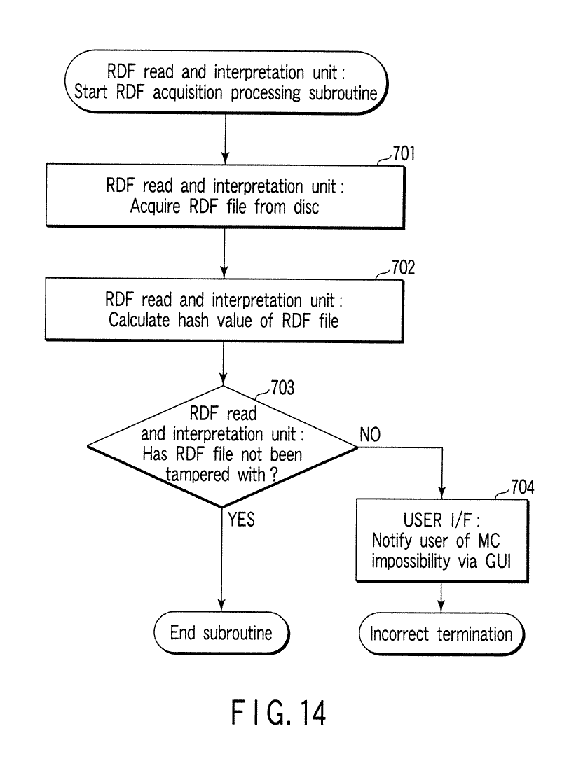

The user instructs the RDF read and interpretation unit 11 to start copying via the user interface 25 (step 601). The RDF read and interpretation unit 11 reads a RDF from the optical disc 3, and sets the RDF to be ready to use a protection scheme defined by the optical disc standard and the like (step 602). Details of the RDF read processing will be exemplified later using FIG. 14.

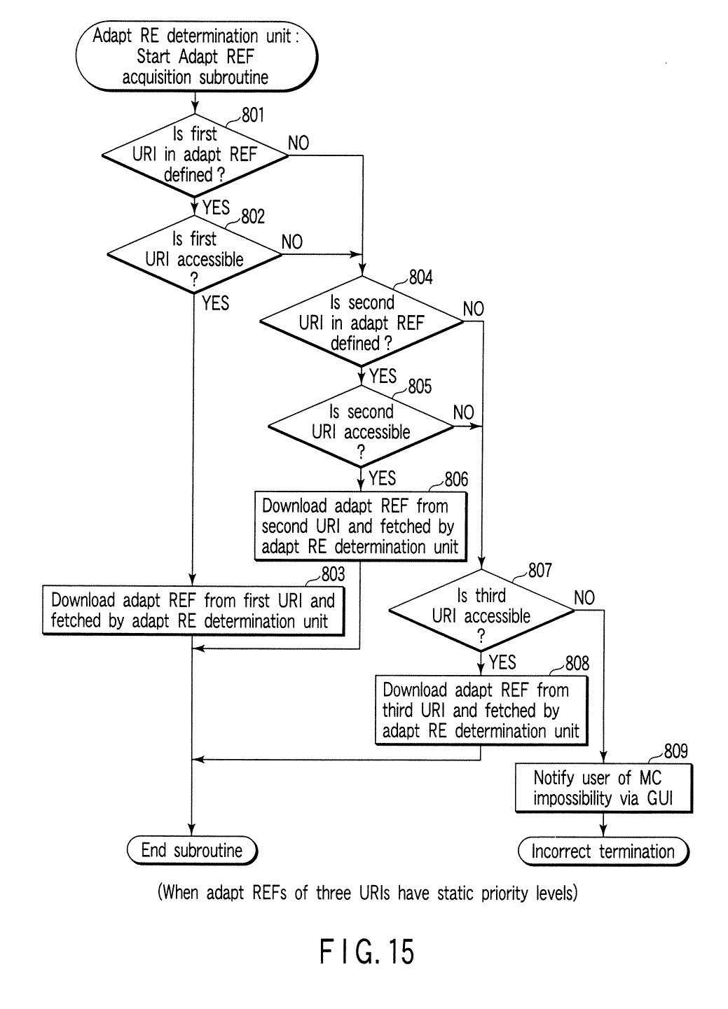

When the RDF becomes ready to use, the Adapt RE determination unit 12 acquires an Adapt REF that the managed copy device 1 is to follow from the three Uri's (201 to 203) described in the RDF (step 603). Details of the Adapt REF acquisition processing will be exemplified later using FIG. 15.

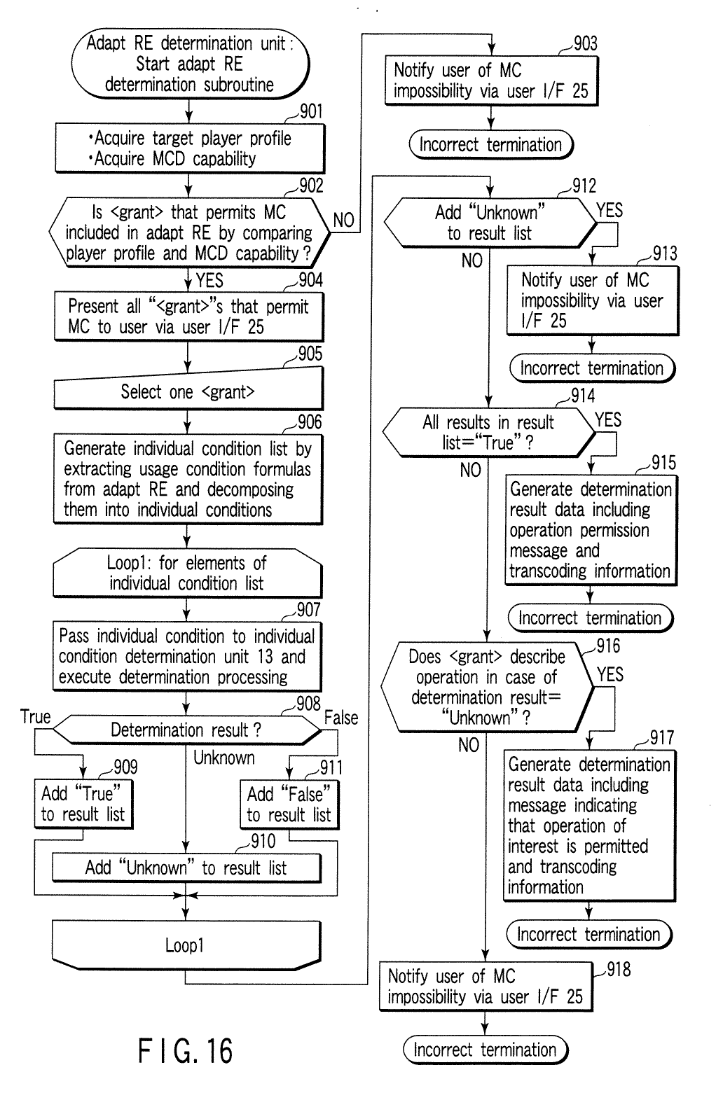

After the Adapt REF is acquired, the Adapt RE determination unit 12 acquires and determines information such as the Target Player Profile 24 and the like required to determine permission/inhibition of copying and copying conditions in accordance with the Adapt RE (step S604). Details of this Adapt RE determination processing will be described later using FIG. 16. Next, the determination result and transcoding parameters are sent to the RDF read and interpretation unit 11 (step 605).

The Adapt RE determination unit 12 notifies the Use REF acquisition unit 14 of a Uri of a Use REF described in the Adapt RE (step 606). The Use REF acquisition unit 14 acquires a Use REF for an RG as the object to be copied from the third REF server 9 whose Uri is designated by the RDF or Adapt RE (step 607).

Upon reception of the copying license condition, the RDF read and interpretation unit 11 notifies the RG transcoding and save unit 10 of information of the RG to be copied and RG transcoding information indicating how to transcode resources which belong to the RG (step 608).

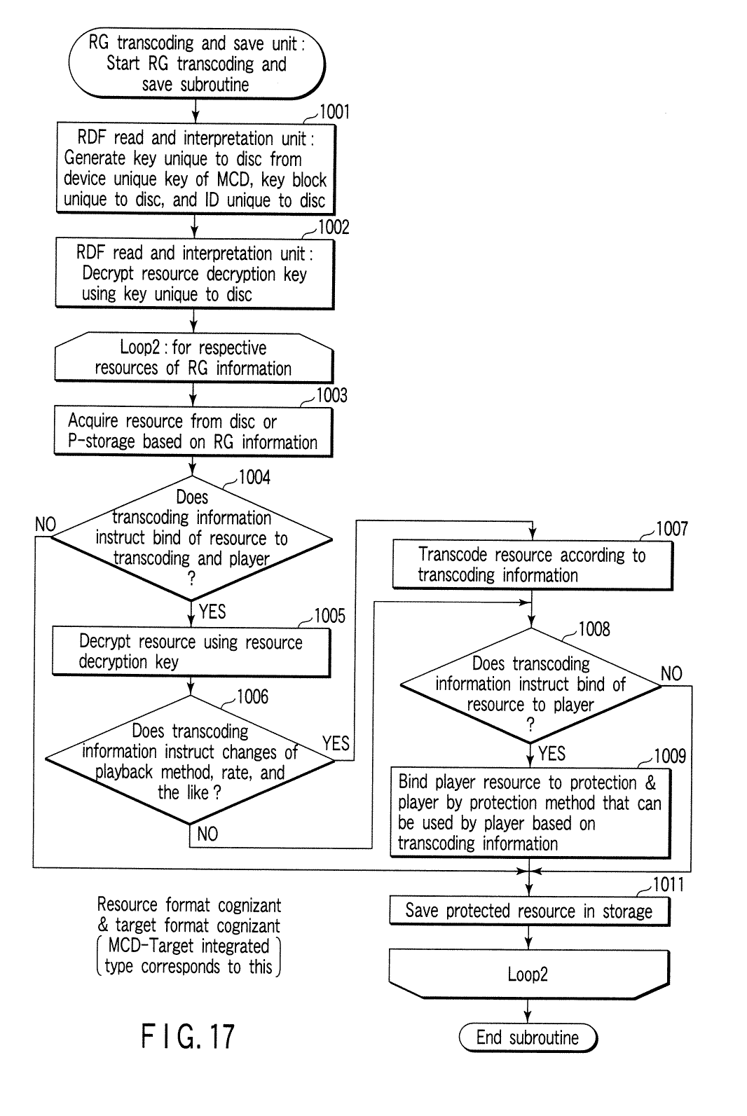

Upon reception of the RG information and transcoding information, the RG transcoding and save unit 10 reads resources on the optical disc 3 or permanent storage 4 according to the RG information, transcodes each individual resource according to the transcoding information, and saves the transcoded resource in the external storage 5 (step 609). Details of the RG transcoding and save processing will be exemplified using FIG. 17.

Upon completion of saving of the RG in the external storage 5, the Use RE acquisition unit 14 saves the Use REF acquired from the third REF server 9 in the external storage 5 (step 610). At this time, the Use RE acquisition unit 14 may transcode the Use REF to be saved in the external storage 5 based on the license condition generated by the Adapt RE determination unit 12 or the RG transcoding information generated by the RDF read and interpretation unit 11 if necessary.

FIG. 14 is a flowchart showing details of the RDF acquisition processing (step 602) in FIG. 13. The read RDF may be protected using a copy protection technique such as hiding based on encryption or tampering protection using hash or MAC as in resources stored on the optical disc 3 or permanent storage 4.

For example, FIG. 14 shows a case wherein the RDF is protected by hashing. In this case, an RDF file is read out from the optical disc 3 or permanent storage 4 (step 701), and its hash value must be calculated (step 702).

The calculated hash value is compared with an expected value of a hash value which is supplied while being protected (step 703). If these two values match, it is determined that the RDF file has not been tampered with. Hence, an RDF stored in the file is ready to be used, and the RDF acquisition processing ends. On the other hand, if the two values do not match, the RDF file may have been damaged or tampered with. Hence, this file is not used, and a message indicating that managed copy cannot be executed is sent to the user via the user interface (step 704), thus ending the overall managed copy processing.

FIG. 15 is a flowchart showing details of the Adapt REF acquisition processing (step 603) in FIG. 13. If the RDF is ready to be used, the Adapt RE determination unit 12 acquires an Adapt REF from one of the three Uri's (201 to 203) shown in FIG. 9. As an acquisition method, priority may often be set in advance for the three Uri's (201 to 203). The Adapt RE determination unit 12 checks first if Uri1 (201) indicating the address in the first REF server 7 is defined (step 801). If Uri1 (201) is defined, the unit 12 tries to download an Adapt REF from Uri1 (201) (step 802). If the Adapt REF can be successfully downloaded, the unit 12 sets the Adapt REF 19 as the one to be used in managed copy (step 803).

Next, if Uri1 (201) is not defined (step 801) or cannot be accessed even if it is defined (step 802), the unit 12 checks whether Uri2 (202) indicating the address in the optical disc or permanent storage is defined (step 804). If Uri2 (202) is defined, the unit 12 tries to download an Adapt REF from Uri2 (202) (step 805). If the Adapt REF can be successfully downloaded, the unit 12 sets the Adapt REF 7 or 18 as the one to be used in managed copy (step 806).

Then, if Uri2 (202) is not defined (step 804) or cannot be accessed even if it is defined (step 805), the unit 12 tries to download an Adapt REF from Uri3 (203) indicating the address in a backup site managed by a permanent organization or the like (step 807). If the Adapt REF can be successfully downloaded, the unit 12 sets the Adapt REF 20 as the one to be used in managed copy (step 808).

If the unit 12 tries to download an Adapt REF from Uri3 (203) (step 807), and cannot successfully download any Adapt REF, it sends a message indicating that managed copy cannot be executed to the user via the user interface 25 (step 809), thus ending the overall managed copy processing.

FIG. 16 is a flowchart showing details of the Adapt RE determination processing (step 604) in FIG. 13. The Adapt RE determination unit 12 acquires the Target Player Profile 24 (step 901), and conducts a search by comparing with the Target Player Profile 24 to inspect if the Adapt RE includes <grant> that permits managed copy (step 902). If no <grant> is included, the unit 12 sends a message indicating that managed copy cannot be made to the user via the user INTERFACE 25 (step 903), thus ending the overall processing.

If <grant> that permits managed copy is found, the unit 12 presents all <grant>s that permit managed copy to the user via the user INTERFACE 25 (step 904), and prompts the user to select one desired <grant> (step 905). The unit 12 then extracts use condition formulas and decomposes them into individual conditions to generate an individual condition list (step 906).

(Loop1)

Next, the unit 12 executes processes in steps 907 to 911 for all elements in the individual condition list.

In Loop1, the unit 12 passes one individual condition to the individual condition determination unit 13 to execute determination processing. The individual condition determination unit 13 makes transactions with processing modules and devices required for determination and obtains a determination result. For example, if the validity interval is included as a condition, the unit 13 inquires a secure timer of a correct time. On the other hand, if an area to be executed is limited, the unit 13 inquires the managed copy device of a valid region code. If the given condition is satisfied, “True” is returned as a determination result; if the given condition is not satisfied, False is returned; or if the determination result is unknown, Unknown is returned.

According to the result of this determination processing (step 908), the unit 12 adds one of these values to a result list (step 909, 910, or 911).

Next, the unit 12 executes determination processing of the overall conditions based on the result list obtained in the above steps (steps 912 to 918). If the result list includes one or more results False, if the individual conditions include those which are not satisfied (step 912), the unit 12 sends a message indicating that managed copy cannot be executed to the user via the user INTERFACE 25 (step 913), thus ending the overall processing.

If all results are “True” (step 914), i.e., if all conditions are cleared (step 914), the unit 12 generates determination result data including an operation permission message and transcoding information (step 915), thus ending this subroutine.

In case other than above, i.e., if there is no condition which is explicitly not satisfied, but there is a condition whose determination result is known (step 914), the unit 12 checks whether <grant> describes an operation (information for determining the operation) in case of an Unknown determination result (step 916). If the corresponding operation is found, the unit 12 generates determination result data including a message indicating that the corresponding operation is permitted, and transcoding information (step 917), thus ending this subroutine.

If the corresponding operation is not found, the unit 12 sends a message indicating that managed copy cannot be executed to the user via the user INTERFACE 25 (step 918), thus ending the overall processing.

FIG. 17 is a flowchart showing the flow of the RG transcoding and save processing (step 609) in FIG. 13. Upon reception of the RG information, license information, and transcoding information from the RDF read and interpretation unit 11, the RG transcoding and save unit 10 starts transcoding of each resource read from the optical disc 3 or permanent storage 4 and saving of the transcoded resource in the external storage 5.

As processing common to resource transcoding, a hidden key unique to the optical disc 3 must be calculated. For this purpose, the RDF read and interpretation unit 11 acquires a key, which is uniquely assigned to and saved in the managed copy device 1, an ID which is stored in and unique to the optical disc 3, and an encrypted unique key block, and calculates the key unique to the optical disc 3 based on these data (step 1001). The unit 11 then decrypts a resource decryption key using the obtained key unique to the optical disc 3 (step 1002). Then, the RG transcoding and save unit 10 executes processes in steps 1003 to 1011 for all resources in the RG information.

(Loop2)

In Loop2, the unit 10 acquires a resource designated by the RG information from the optical disc 3 or permanent storage 4 (step 1003). If the transcoding information designates arbitrary format transcoding of the acquired resource (step 1004), the unit 10 decrypts the resource using the resource decryption key (step 1005).

If transcoding designated by the transcoding information instructs transcoding of a content itself such as a change of the content playback method or playback rate, and the like, except for the protection scheme (step 1006), the unit 10 transcodes the resource according to the transcoding information (step 1007).

If the transcoding information instructs to protect the resource so as not to be played back by players other than the designated player (player 6) (step 1008), the unit 10 processes as follows. That is, the unit 10 protects the resource by a protection scheme that can be used by the player 6, which is designated by the transcoding information (or transcoding method), and associates (binds) the ID unique to the player 6 and the like with the protection method that can be used by the player 6. In this way, other players which do not have any ID unique to the player 6 and the like can be inhibited from using the resource (step 1009).

On the other hand, if the transcoding information does not designate any protection associated with the player 6 upon protecting the resource (step 1008), the unit 10 handles the resource as follows. That is, the unit 10 merely protects the resource by a protection method which can be used by the player 6 designated by the transcoding information without any ID unique to the player 6 and the like (step 1010). The unit 10 stores the transcoded and protected resource in the external storage 5 (step 1011).

On the other hand, if the transcoding information does not designate any format transcoding of the acquired resource, the unit 10 directly saves the resource in the external storage 5 without any processing such as decryption, transcoding, and the like (step 1011).

If all the resources designated by the RG information are saved in the external storage 5, the RG transcoding and save processing ends. On the other hand, if resources which are designated by the RG information and are not saved in the external storage 5 still remain, the unit 10 reads the next resource designated by the RG information from the optical disc 3 or permanent storage 4, and continues the RG transcoding and save processing (Loop2).

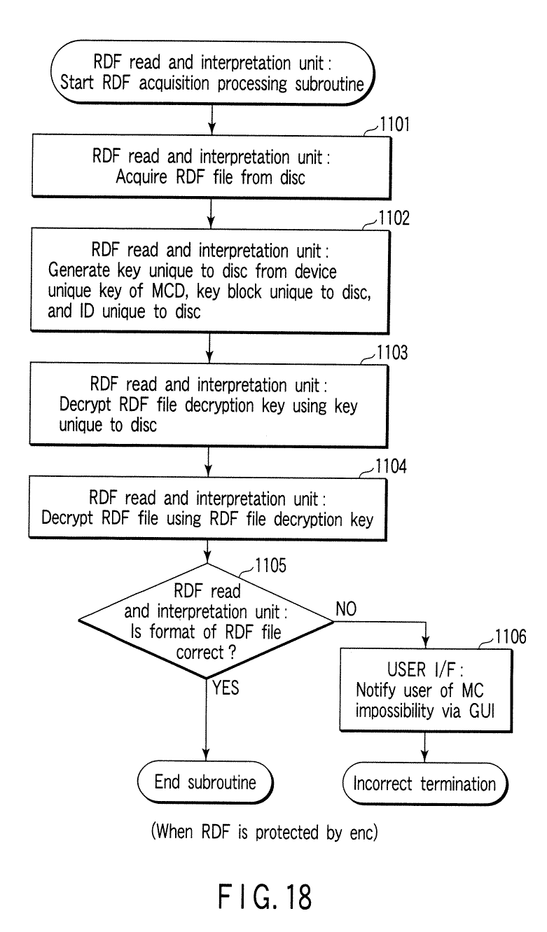

The invention is not limited to the aforementioned embodiment. FIG. 18 is a flowchart showing another (second) embodiment of the RDF acquisition processing (step 602) in FIG. 13.

The first embodiment in FIG. 14 above has explained a case wherein the RDF is protected by hashing. FIG. 18 shows a case wherein the RDF is hidden by encryption. In this case, an RDF file read out from the optical disc 3 or permanent storage 4 cannot be used intact, and the RDF file must be decrypted first.

Initially, an RDF file is read out from the optical disc 3 or permanent storage 4 (step 1101). In order to decrypt the RDF file, a hidden key unique to the optical disc 3 must be calculated. For this purpose, the RDF read and interpretation unit 11 acquires a key, which is uniquely assigned to and saved in the managed copy device 1, an ID which is stored in and unique to the optical disc 3, and an encrypted unique key block. The unit 11 then calculates the key unique to the optical disc 3 based on these acquired data (step 1102).

The unit 11 decrypts an RDF file decryption key using the obtained key unique to the optical disc 3 (step 1103). The unit 11 then decrypts the RDF file using the obtained RDF file decryption key (step 1104). Finally, the unit 11 checks whether the decrypted file has a format that can be interpreted by the RDF read and interpretation unit 11 (step 1105). If the file has a format that can be interpreted, an RDF in the file is ready to be used, thus ending the RDF read processing.

On the other hand, if the format cannot be interpreted, any of the encrypted RDF file, the key unique to the device, the ID unique to the optical disk 3, and the encrypted unique key block may be damaged or tampered with. In such case, the unit 11 sends a message indicating that managed copy cannot be executed to the user via the user interface 25 (step 1106), thus ending the overall managed copy processing.

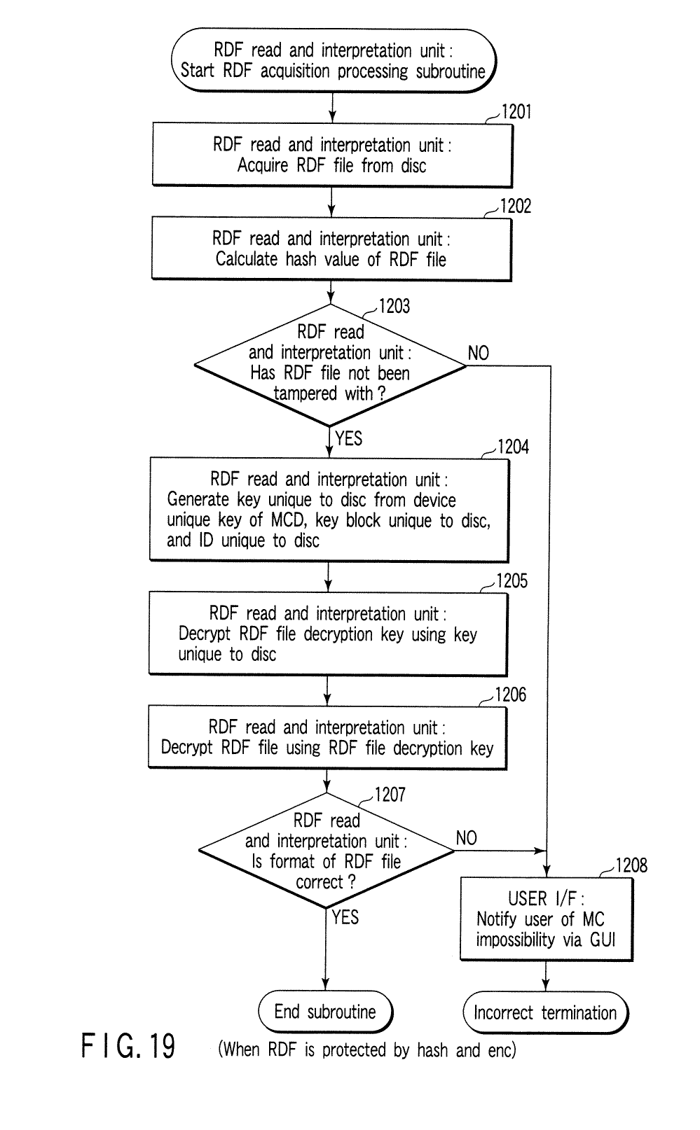

The invention is not limited to the aforementioned embodiment. FIG. 19 is a flowchart showing still another embodiment of the RDF acquisition processing (step 602) in FIG. 13.

The first embodiment in FIG. 14 above has explained a case wherein the RDF is protected by hashing, and the second embodiment in FIG. 18 has explained a case wherein the RDF is hidden by encryption. FIG. 19 shows a case wherein the RDF is hidden by encryption, and the encrypted RDF is protected by hashing. In this case, an RDF file read out from the optical disc 3 or permanent storage 4 cannot be used intact.

Initially, the RDF read and interpretation unit 11 reads an RDF file from the optical disc 3 or permanent storage 4 (step 1201). The unit 11 then calculates a hash value of the RDF file (step 1202). The unit 11 compares the calculated hash value with an expected value of a hash value which is supplied while being protected (step 1203). If these two values match, it is determined that the RDF file has not been tampered with. Hence, the unit 11 then executes decryption.

In order to decrypt the RDF file, a hidden key unique to the optical disc 3 must be calculated. For this purpose, the unit 11 acquires a key, which is uniquely assigned to and saved in the managed copy device 1, an ID which is stored in and unique to the optical disc 3, and an encrypted unique key block. The unit 11 then calculates the key unique to the optical disc 3 based on the acquired data (step 1204).

The unit 11 decrypts an RDF file decryption key using the obtained key unique to the optical disc 3 (step 1205). The unit 11 then decrypts the RDF file using the obtained RDF file decryption key (step 1206).

Finally, the unit 11 checks whether the decrypted file has a format that can be interpreted by the RDF read and interpretation unit 11 (step 1207). If the file has a format that can be interpreted, an RDF in the file is ready to be used, thus ending the RDF read processing.

On the other hand, if the hash value does not match the expected value (step 1203), and if the format cannot be interpreted (step 1207), any of the encrypted RDF file, the key unique to the device, the ID unique to the optical disk 3, and the encrypted unique key block may have been damaged or tampered with. In such case, the unit 11 sends a message indicating that managed copy cannot be executed to the user via the user interface 25 (step 1208), thus ending the overall managed copy processing.

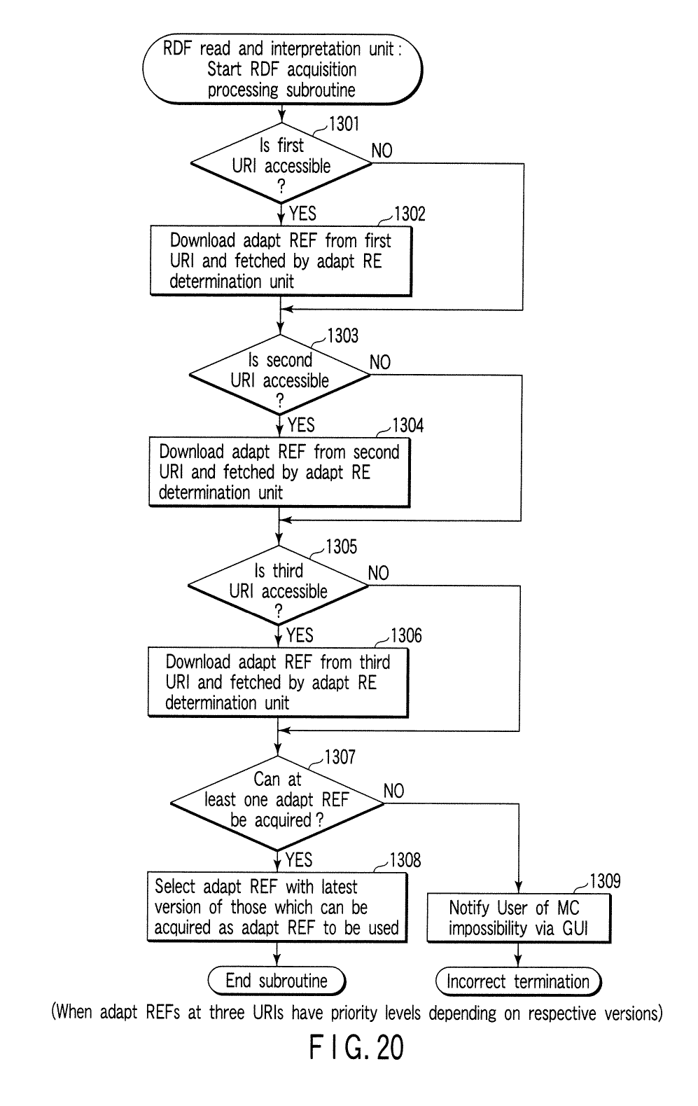

FIG. 20 is a flowchart showing another embodiment of the Adapt REF acquisition processing (step 603) in FIG. 13.

FIG. 20 shows a case wherein no priority is set for three Uri's (201 to 203). Initially, if Uri1 (201) indicating the address in the first REF server 7 is accessible (step 1301), the Adapt RE determination unit 12 executes downloading (step 1302). If Uri2 (202) indicating the address in the optical disc or permanent storage is accessible (step 1303) independently of whether or not downloading from Uri (201) has succeeded, the unit 12 executes downloading (step 1304).

Next, if Uri3 (203) indicating the address in a backup site managed by a permanent organization or the like is accessible (step 1305) independently of whether or not downloading from Uri1 (201) and Uri2 (202) has succeeded, the unit 12 executes downloading (step 1306).

With the processes executed so far, a maximum of three Adapt REFs are downloaded. However, if none of Adapt REFs is successfully downloaded (step 1307), the unit 12 sends a message indicating that managed copy cannot be executed to the user via the user interface 25 (step 1309), thus ending the overall managed copy processing.

If one or more Adapt REFs can be downloaded (step 1307), the unit 12 refers to the versions of these Adapt REFs, and sets the latest one of these Adapt REFs as the one to be used in managed copy (step 1308).

In this embodiment, the three Uri's have been explained. However, when the method of referring to the versions of the Adapt REFs shown in FIG. 20 is adopted, four or more Uri's can be designated.

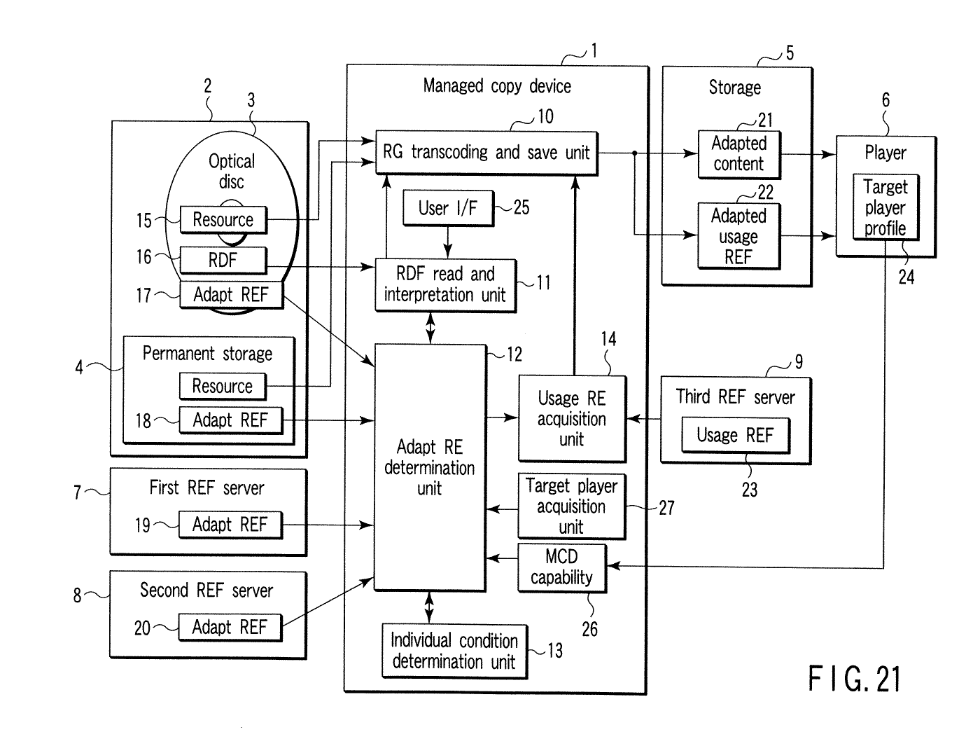

FIG. 21 is a functional block diagram showing still another embodiment according to the invention. The same reference numerals in FIG. 21 denote the same functional blocks as in the previous embodiments. In this embodiment, the Target Player Profile 24 is held not by the managed copy device 1 but the player 6. For this reason, in this embodiment, the managed copy device 1 further has a Player Profile acquisition unit 27, and acquires the Target Player Profile 24 via a transaction with the player 6. Other functional blocks are the same as those in the above embodiments.

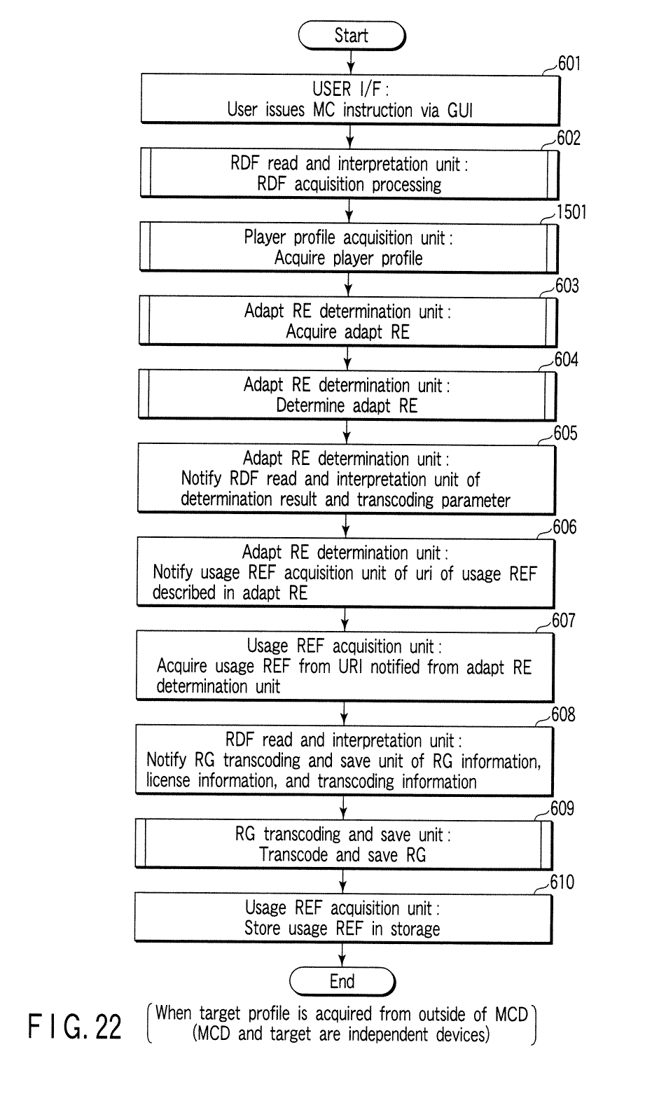

FIG. 22 is a flowchart showing the flow of the overall processing in the functional blocks shown in FIG. 21. In this embodiment, Target Player Profile acquisition processing (step 1501) is added after the RDF acquisition processing in addition to the flow of FIG. 13. Since other processing steps are the same as those in FIG. 13, the same step numbers as in FIG. 13 are assigned.

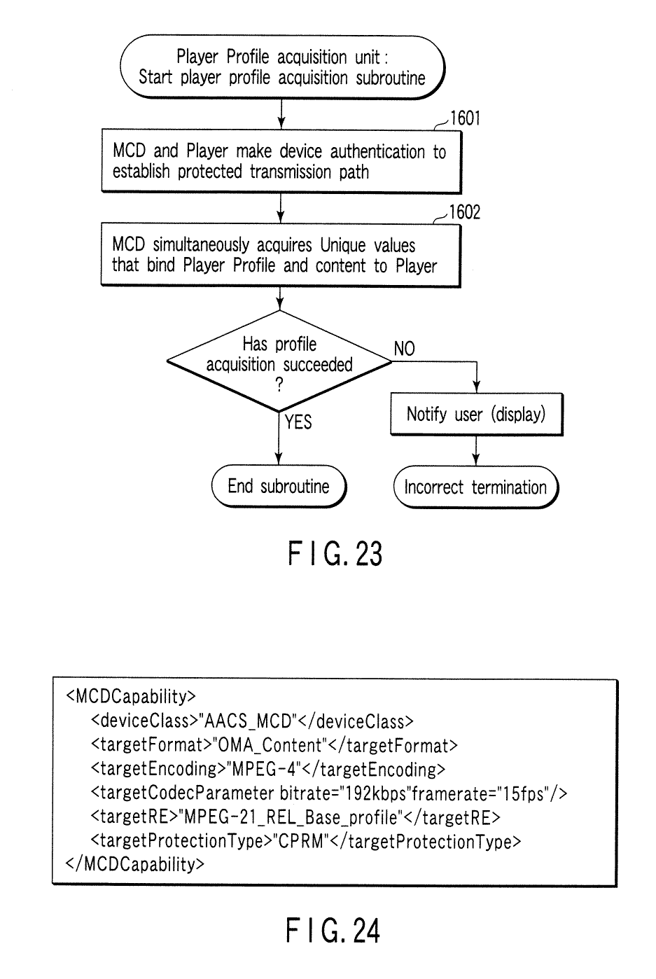

FIG. 23 shows details of the processing flow executed in the Target Player Profile acquisition processing (step 1501). Initially, the managed copy device 1 and player 6 perform device authentication to establish a protected transmission path (step 1601). Actual processing may be implemented using a scheme of an existing secure protocol. For example, a DTCP protocol, UPnP communication protocol, or the like may be used. The managed copy device 1 simultaneously acquires unique values which bind the Target Player Profile and content to the player 6 (step 1602). If the Profile acquisition has succeeded, the processing ends, and the flow advances to the next step 603. If the Profile acquisition has failed, the Player Profile acquisition unit 27 sends a message indicating that managed copy cannot be executed to the user via the user interface 25, thus ending the overall processing.

FIG. 24 shows a description example of the MCD Capability data 26 in this embodiment. In this example, the transcoding capability of the MCD itself is described.

This data is used to retrieve corresponding <grant> from a plurality of <grant>s included in the Adapt RE shown in FIG. 10. This data may use an existing Profile format by introducing an appropriate matching method and, for example, ISO/IEC 21000-7 (MPEG-21 DIA: Digital Item Adaptation) or the like may be used.

The invention is not limited to the above embodiments. In the above embodiments, the license server transmits license information to the managed copy device 1 while appending the MAC to it. However, the invention is not limited to the MAC, and various other methods may be used.

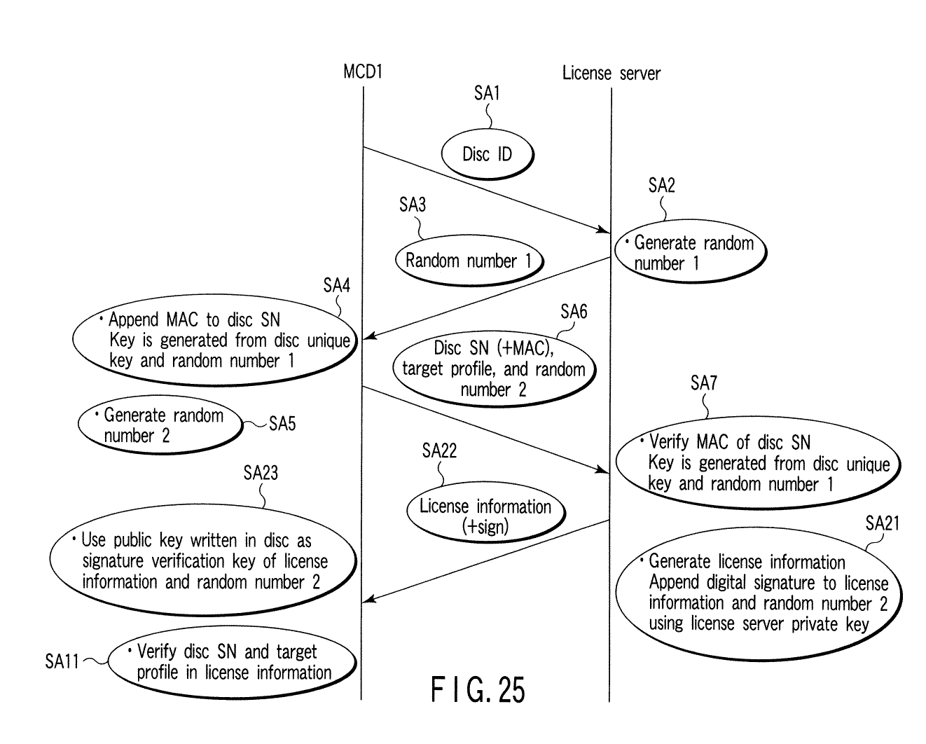

FIG. 25 shows an example in which a Signature is used in place of the MAC. FIG. 25 corresponds to FIG. 5, and shows another example of the minimum protocol used to obtain protection of data to be protected. Signal contents in steps SA21, SA22, and SA23 are different from the example of FIG. 5. The aforementioned MAC is tamper-resistant code based on common key encryption, and the managed copy device and license server generate an identical key. However, the example of FIG. 25 is based on public key encryption. The public key encryption is a scheme using a pair of a private key and public key. For example, a signature used in this embodiment is to sign data to be transmitted (license information and random number 2) using a private key (step SA21). On the other hand, the managed copy device side (receiving side) verifies the signature using a public key (step SA23). In this embodiment, a public key which is paired with a private key used by the license server is recorded in advance on the disc. Other steps are the same as those in the example of FIG. 5.

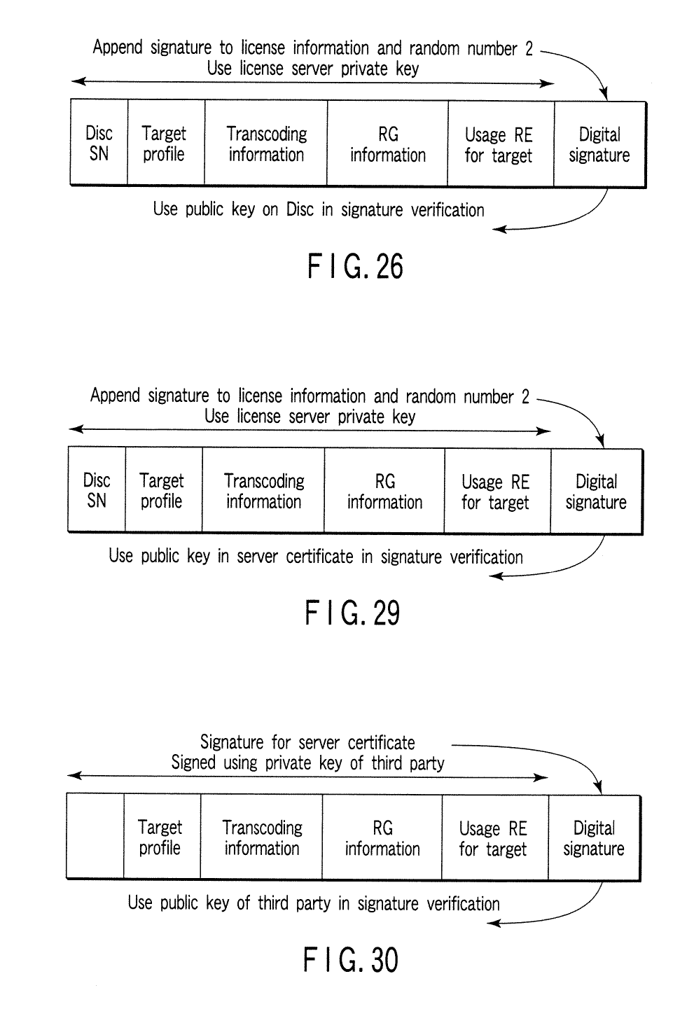

FIG. 26 shows a format example of license information to be handled in step SA22 in FIG. 25. As compared to FIG. 7A, the MAC field is replaced by that of a digital signature. Other fields are the same as those in the above embodiments.

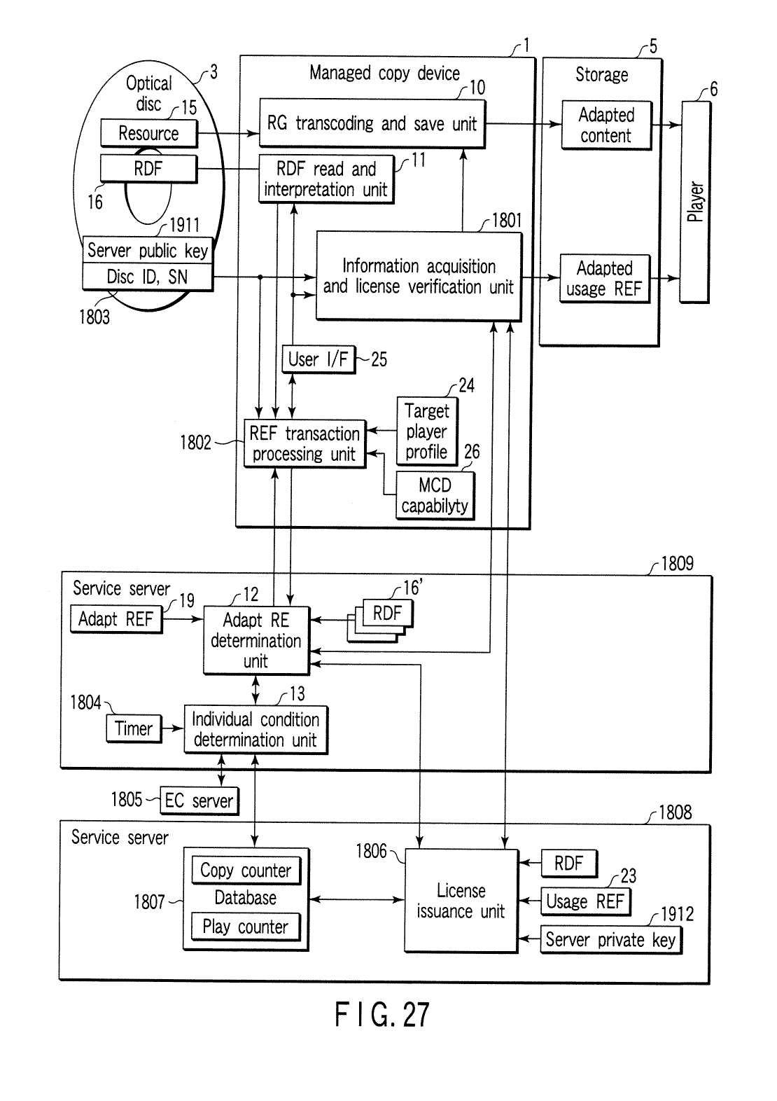

FIG. 27 shows the overall configuration of an apparatus to which the embodiment described using FIGS. 25 and 26 is applied. Differences from the configuration in FIG. 1 are that a public key 1911 is recorded in advance in the optical disc 3, and a private key 1912 is prepared in the license server. Other blocks are the same as those in the above embodiment, and the same reference numerals in FIG. 27 denote the same blocks.

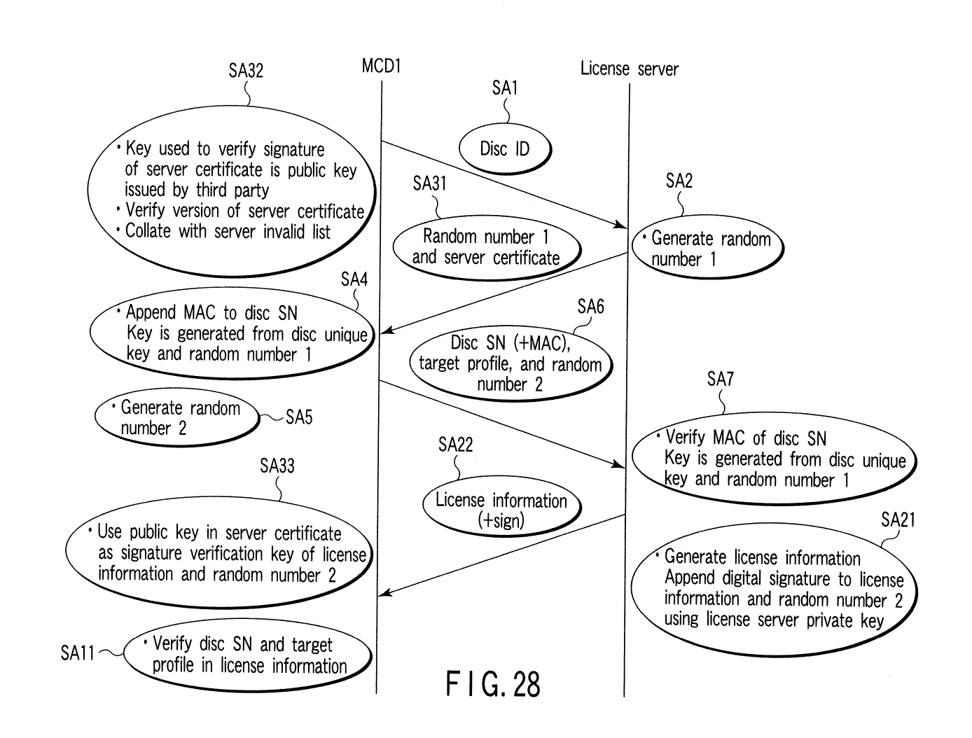

FIG. 28 is a chart showing yet another embodiment of the invention. In this embodiment, a public key is passed from the license server to the MCD in a communication between the managed copy device (MCD) and the license server.

Unlike in the example of FIG. 25, the license server issues a server certificate (digital information) (step SA31) in this example. At this time, a signature issued by a trustworthy third party such as a license organization or the like is appended to the entire certificate. The managed copy device (MCD) 1 verifies using a public key for signature verification of the third party whether or not the server certificate is counterfeited. The server certificate to be verified includes version information, a server ID, a server public key, an invalid list version, a server invalid list, and the like. These pieces of information are checked to verify that the server certificate is not counterfeited (step SA32). To confirm the authenticity of the server certificate, the following processing is also executed. That is, the version of the certificate is collated with data indicating a minimum version on the disc (e.g., data stored in the RDF) to confirm if the server certificate is old. The ID of the server is collated with the server invalid list stored in the MCD, and if the server is not invalid, it is determined that the server that issued the server certificate is trustworthy. On the other hand, if the invalid list version is newer than that held in the managed copy device (MCD), the server invalid list and invalid list version of the MCD are updated.

If it is confirmed via the aforementioned processing that the server is authentic, a public key of the server is ready to be used. The subsequent processing is the same as that in the above embodiment.

According to the above embodiment, it becomes more difficult for a person who illicitly acquires key information or the like to use a false license server. Furthermore, the embodiment shown in FIG. 28 can eliminate setting of an illicit license server.

FIGS. 29 and 30 show examples of the format of the license information and the transmission format of the server certificate, which are adopted in the embodiment shown in FIG. 28.

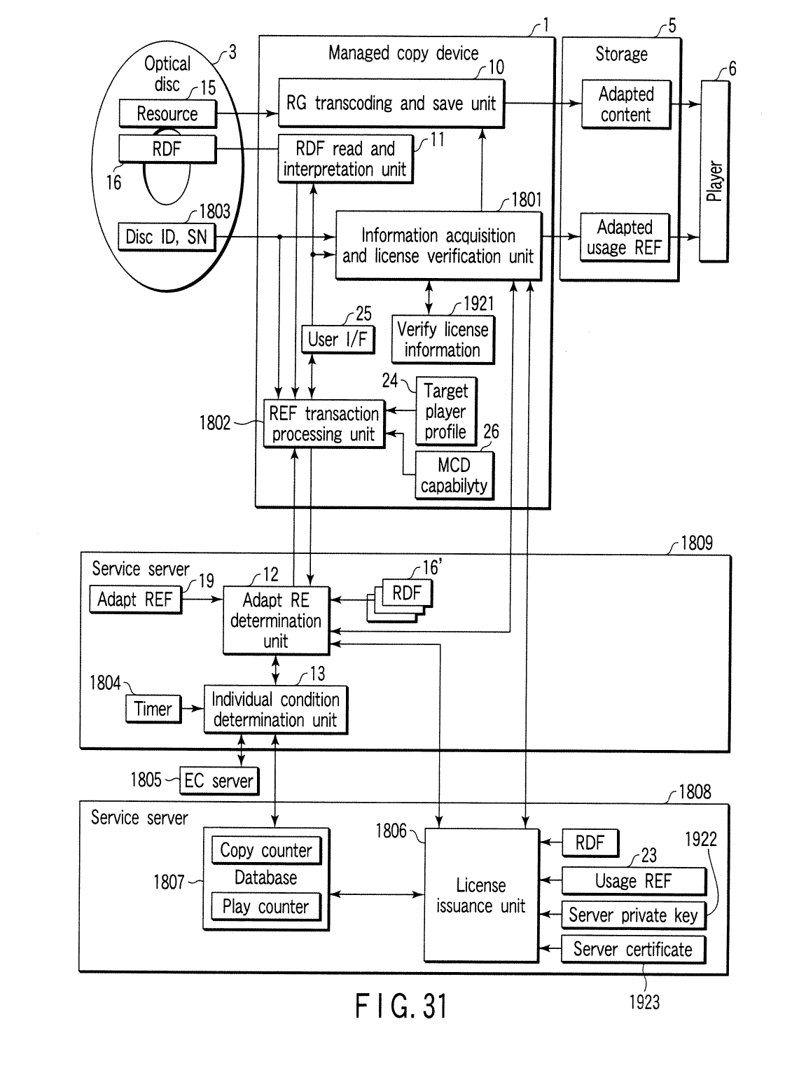

FIG. 31 is a block diagram of the overall apparatus corresponding to the aforementioned embodiment. Compared to the embodiment shown in FIG. 1, a server invalid list save unit 1921 is added to the managed copy device 1. To the license server 1808, a server secret key unit 1922 and server certificate unit 1923 are added.

Note that the invention is not limited to the embodiments intact, and it can be embodied by modifying required constituent elements without departing from the scope of the invention when it is practiced. Also, various inventions can be formed by appropriately combining a plurality of required constituent elements disclosed in the respective embodiments. For example, some required constituent elements may be omitted from all required constituent elements disclosed in the respective embodiments. Furthermore, required constituent elements of different embodiments may be appropriately combined.

According to the invention, the following effects can be provided. That is, content data saved in the optical disc can be protected from being illicitly copied, a copy can be permitted under appropriate use control, and use contents different from a copy source can be licensed to a copy.

<Supplementary Explanation>

As the license conditions for such copying operation, for example, whether or not a device that uses a copy is authenticated by an organization, whether or not a format is authorized by the organization, and the like are described. The contents provider normally prepares the Adapt RE via the network. However, since it is premised on that the permanent organization always prepares for a default Adapt RE as a backup, variations due to economic circumstances on the contents provider side can be absorbed. Furthermore, the Adapt RE may be described in an optical disc in advance. Next, for a content which is copied after the above conditions are satisfied, use control different from an original can be made based on the Use RE. For example, playback of the copy may be limited to a predetermined period of time, and playback at a high resolution may be charged. Furthermore, since the acquisition destination of the Use RE is obtained by referring to the Adapt RE, the Use RE may be described in a format different from the Adapt RE. For this reason, if the Use RE is prepared in advance in an expression format that can be handled by the target device, complicated processing such as RE transcoding processing and the like can be avoided.

For example, when the target device complies with OMA (Open Mobile Alliance) DRM (Digital Rights Management) Ver2.0, the Adapt RE may be described in the format of MPEG-21 REL, and the Use RE may be prepared in a format of REL (Rights Expression Language) specified by OMA. As a matter of course, the Use RE may be expressed by MPEG-21 REL, and may be transcoded so as to be processed by the target device. If the Adapt RE is embedded as a part of the Use RE, new use control may be done using a similar scheme for another copy.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modification as would fall within the scope and spirit of the inventions.

What is claimed is:

1. A digital content use apparatus comprising:
a disc device configured to read information from an optical disc that describes content data, a resource description file including acquisition destination information of an adapt right description file which describes resource information, identification information, and the execution contents and conditions of copying of the content to be handled as units of copying processing, disc identification information, and a disc serial number;
a communication start unit configured to transmit the read disc identification information to a server;
a first response unit configured to transmit, when the server supports the disc identification information and first key information (random number 1) is returned from the server, information prepared by appending, to the disc serial number, a tamper-resistant code generated using key information unique to the disc and the first key information (random number 1), second key information (random number 2), and a target profile of a player to be used to the server; and
a second response unit configured to store, when the server verifies whether or not the tamper-resistant code is normal and determines whether or not the disc serial number is authentic, license information which includes the disc serial number, the target profile, transcoding information used to copy a resource, and use limitation information used to limit use of a copied content, and to which a tamper-resistant code is appended using a disc unique key and the second key information (random number 2) by the server is received from the server, and the temper-resistant code of the license information is verified to obtain authenticity, the use limitation information being stored in a storage, and to supply the transcoding information to a transcoding and save unit configured to transcode the resource and to save the transcoded resource in the storage based on the transcoding information.

2. The apparatus according to claim 1, wherein the communication start unit comprises a read and interpretation unit configured to read and interpret the resource description file, and an REF transaction processing unit configured to transmit acquisition destination information to the server,
the first response unit comprises the REF transaction processing unit configured to read the disc serial number, and
the second response unit comprises an information acquisition and license verification unit configured to receive the license information.

3. The apparatus according to claim 1, wherein the first response unit comprises an REF transaction processing unit configured to read the disc serial number, and managed copy device capability (MCD Capability) data that describes transcoding processing performance of the transcoding and save unit.

4. The apparatus according to claim 1, wherein the first response unit comprises a unit configured to acquire the target profile.

5. The apparatus according to claim 1, wherein the acquisition destination information of the adapt right description file describes at least two pieces of the acquisition destination information.

6. The apparatus according to claim 1, wherein the acquisition destination information of the adapt right description file describes at least two pieces of the acquisition destination information, and the one acquisition destination information indicates a file recorded in the optical disc.

7. The apparatus according to claim 1, wherein the communication start unit comprises a read and interpretation unit configured to read and interpret the resource description file, an REF transaction processing unit configured to transmit acquisition destination information to the server, and a unit configured to select, when a plurality of pieces of acquisition destination information are available, one acquisition destination information based on predetermined priority or one acquisition destination information with a latest version.

8. The apparatus according to claim 1, wherein the communication start unit comprises a read and interpretation unit configured to read and interpret the resource description file, and when the resource description file is a hidden file protected by a hash value or encryption processing, the read and interpretation unit includes a verification and decryption unit corresponding to a protection scheme of the hidden file.

9. The apparatus according to claim 1, wherein the server is formed by a plurality of servers.

10. A digital content use method for a system which comprises a disc device configured to read information from an optical disc that describes content data, a resource description file including acquisition destination information of an adapt right description file which describes resource information, identification information, and the execution contents and conditions of copying of the content to be handled as units of copying processing, disc identification information, and a disc serial number, a communication start unit, a first response unit, and a second response unit, comprising:
controlling the communication start unit to transmit the read disc identification information to a server;
controlling, when the server supports the disc identification information and first key information (random number 1) is returned from the server, the first response unit to transmit information prepared by appending, to the disc serial number, a tamper-resistant code generated using key information unique to the disc and the first key information (random number 1), second key information (random number 2), and a target profile of a player to be used to the server; and
controlling, when the server verifies whether or not the tamper-resistant code is normal and determines whether or not the disc serial number is authentic, license information which includes the disc serial number, the target profile, transcoding information used to copy a resource, and use limitation information used to limit use of a copied content, and to which a tamper-resistant code is appended using a disc unique key and the second key information (random number 2) by the server is received from the server, and the temper-resistant code of the license information is verified to obtain authenticity, the second response unit to store the use limitation information in a storage, and to supply the transcoding information to a transcoding and save unit configured to transcode the resource and to save the transcoded resource in the storage.

11. The method according to claim 10, further comprising:
controlling the communication start unit to acquire the acquisition destination information by reading and interpreting the resource description file using a read and interpretation unit, and transmit acquisition destination information to the server using an REF transaction processing unit;
controlling the first response unit to read the disc serial number using the REF transaction processing unit; and
controlling the second response unit to receive the license information using an information acquisition and license verification unit.

12. The method according to claim 10, wherein the method further comprises controlling the server to
detect a target profile and grant information suited to managed copy capability from the adapt right description file acquired based on the acquisition destination information, and acquire use condition information including individual conditions associated with use of a copy from the detected grant information,
determine by comparing the individual conditions with the target profile and the managed copy capability information whether or not the individual conditions are satisfied, and
generate, when a result list indicating condition determination result is satisfied, the license information including the transcoding information and the use limitation information used to limit use of the copied content.

13. The method according to claim 10, wherein the server is divided into a service server and a license server, and
the method further comprises:
controlling the service server to
detect a target profile and grant information suited to managed copy capability from the adapt right description file acquired based on the acquisition destination information, and acquire use condition information including individual conditions associated with use of a copy from the detected grant information, and
determine by comparing the individual conditions with the target profile and the managed copy capability information whether or not the individual conditions are satisfied; and
controlling the license server to
generate, when a result list indicating condition determination result is satisfied, the license information including the transcoding information and the use limitation information used to limit use of the copied content.

14. The method according to claim 10, further comprising:
controlling the communication start unit to
acquire the acquisition destination information by reading and interpreting the resource description file using a read and interpretation unit,
transmit the acquisition destination information to the server using an REF transaction processing unit, and
access, when a copying license is not determined since the server does not have disc identification information of an optical disc to be copied, an address of another server of the optical disc.

15. The method according to claim 10, further comprising: controlling the server to
detect a target profile and grant information suited to managed copy capability from the adapt right description file acquired based on the acquisition destination information, and acquire use condition information including individual conditions associated with use of a copy from the detected grant information,
determine by comparing the individual conditions with the target profile and the managed copy capability information whether or not the individual conditions are satisfied, and
access, when the adapt right description file describes a condition associated with accounting upon determining the individual conditions, an EC server and execute settlement process to satisfy the accounting condition.

16. The method according to claim 10, further comprising: controlling the server to
detect a target profile and grant information suited to managed copy capability from the adapt right description file acquired based on the acquisition destination information, and acquire use condition information including individual conditions associated with use of a copy from the detected grant information,
determine by comparing the individual conditions with the target profile and the managed copy capability information whether or not the individual conditions are satisfied, and
further use, when the adapt right description file describes a condition associated with a time period such as a validity interval or the like upon determining the individual conditions, a timer used to determine the time condition.

17. The method according to claim 10, wherein the server is divided into a service server and a license server, and the license server comprises a copy counter and a play counter as a database, and
the method further comprises:
controlling the service server to
detect a target profile and grant information suited to managed copy capability from the adapt right description file acquired based on the acquisition destination information, and acquire use condition information including individual conditions associated with use of a copy from the detected grant information,
determine by comparing the individual conditions with the target profile and the managed copy capability information whether or not the individual conditions are satisfied, and
communicate with, when the adapt right description file describes a condition associated with a copy count limitation and/or a playback count limitation, the license server to determine the count limitations based on the counter; and
controlling the license server to
generate, when a result list indicating condition determination result is satisfied, the license information including the transcoding information and the use limitation information used to limit use of the copied content.

18. In a form using a managed copy device which comprises a disc device configured to read information from an optical disc that describes content data, a resource description file including acquisition destination information of an adapt right description file which describes resource information, identification information, and the execution contents and conditions of copying of the content to be handled as units of copying processing, disc identification information, and a disc serial number, a communication start unit, a first response unit, and a second response unit, and a license server configured to communicate with the managed copy device, a digital content use method for protecting license information from tampering and illicit decryption by making a transaction method execute:
first processing of transmitting the disc identification information from the managed copy device to the license server;
second processing of transmitting random number 1 generated by the license server to the managed copy device;
third processing of making the managed copy device generate a key for a tamper-resistant code (MAC) from a disc unique key based on the disc identification information and the random number 1, and appending the MAC to the disc serial number;
fourth processing of making the managed copy device generate random number 2, and transmitting the random number 2, the Target Profile, and the disc serial number appended with the MAC to the license server;
fifth processing of making the license server verify the MAC of the disc serial number;
sixth processing of generating license information when the license server confirms that the MAC of the disc serial number is authentic;
seventh processing of making the license server generate a key for a MAC from the disc unique key and the random number 2, appending the MAC to the license information, and transmitting the license information to the managed copy device;
eighth processing of making the managed copy device verify the MAC of the license information; and
ninth processing of making the managed copy device verify if the disc serial number and the Target Profile included in the license information are authentic.

19. The method according to claim 18, wherein the license information is generated and exchanged in a format configured by a description of at least the disc serial number, the Target Profile, transcoding information, resource group information, and use limitation information.

20. A digital content use apparatus comprising:
a disc device configured to read information from an optical disc that describes content data, a resource description file including acquisition destination information of an adapt right description file which describes resource information, identification information, and the execution contents and conditions of copying of the content to be handled as units of copying processing, disc identification information, and a disc serial number;
a communication start unit configured to transmit the read disc identification information to a server;
a first response unit configured to transmit, when the server supports the disc identification information and first key information (random number 1) is returned from the server, information prepared by appending, to the disc serial number, a tamper-resistant code generated using key information unique to the disc and the first key information (random number 1), second key information (random number 2), and a target profile of a player to be used to the server; and
a second response unit configured to store, when the server verifies whether or not the tamper-resistant code is normal and determines whether or not the disc serial number is authentic, license information which includes the disc serial number, the target profile, transcoding information used to copy a resource, and use limitation information used to limit use of a copied content, and which is obtained by appending a digital signature using a server private key to the license information and the second key information (random number 2) by the server is received from the server, and authenticity of the digital signature is obtained using a server public key on the disc, the use limitation information being stored in a storage, and to supply the transcoding information to a transcoding and save unit configured to transcode the resource and to save the transcoded resource in the storage based on the transcoding information.

21. The apparatus according to claim 20, wherein the communication start unit comprises a read and interpretation unit configured to read and interpret the resource description file, and an REF transaction processing unit configured to transmit acquisition destination information to the server,
the first response unit comprises the REF transaction processing unit configured to read the disc serial number, and
the second response unit comprises an information acquisition and license verification unit configured to receive the license information and the server public key from the disc.

22. A digital content use apparatus comprising:
a disc device configured to read information from an optical disc that describes content data, a resource description file including acquisition destination information of an adapt right description file which describes resource information, identification information, and the execution contents and conditions of copying of the content to be handled as units of copying processing, disc identification information, and a disc serial number;
a communication start unit configured to transmit the read disc identification information to a server;
a first response unit configured to transmit, when the server supports the disc identification information and first key information (random number 1) is returned from the server, information prepared by appending, to the disc serial number, a tamper-resistant code generated using key information unique to the disc and the first key information (random number 1), second key information (random number 2), and a target profile of a player to be used to the server, and to check, when a server certificate appended with a signature is transmitted from the server, authenticity of the server certificate; and
a second response unit configured to store, when the server verifies whether or not the tamper-resistant code is normal and determines whether or not the disc serial number is authentic, license information which includes the disc serial number, the target profile, transcoding information used to copy a resource, and use limitation information used to limit use of a copied content, and which is obtained by appending a digital signature using a server private key to the license information and the second key information (random number 2) by the server is received from the server, and authenticity of the digital signature is obtained using a public key in the server certificate, the use limitation information being stored in a storage, and to supply the transcoding information to a transcoding and save unit configured to transcode the resource and to save the transcoded resource in the storage based on the transcoding information.

23. The apparatus according to claim 22, wherein the server certificate includes a certificate version, a server ID, a server public key, an invalid list version, and a server invalid list.
